(19) United States
(12) Patent Application Publication
(10) Pub. No.: US 2009/0140119 A1
(43) Pub. Date: Jun. 4, 2009

(54) SUPPORT STAND FOR NOTEBOOK

(76) Inventors: Chun Yuen To, Hong Kong (CN); Hung Yu Cheng, Hong Kong (CN)

Correspondence Address: SENNIGER POWERS LLP, 100 NORTH BROADWAY, 17TH FLOOR, ST LOUIS, MO, 63102, US

(21) Appl. No.: 11/948,163

(22) Filed: Nov. 30, 2007

(51) Int. Cl. A47B 97/04; A47F 5/10; F16M 11/38; B42D 3/00; A47B 23/00

(52) U.S. Cl. 248/455; 248/128; 248/436; 281/33; 281/45; 248/441.1

(57) ABSTRACT

A stand for supporting a structure (e.g., a notebook) for holding one or more pages includes a mounting member adapted to engage the structure. A support member secured to the mounting member is moveable between a stowed and support positions. The support member includes a pair of legs defining at least in part a base of the support member. Each of the legs is selectively reconfigurable between a first configuration in which the leg has a relatively shorter length and a second configuration in which the leg has a relatively longer length. When the legs are in the relatively shorter configuration, the stand may be used to support the structure in an inclined position on a work surface. When the legs are in the longer configuration, the stand may be used to retain the structure in self-supporting configuration so the structure can support itself upright on the work surface.

### FIELD OF THE INVENTION

The present invention is generally related to support stands, and more particularly to methods and apparatus for supporting a structure, such as a notebook, that is used to hold loose-leaf pages so the structure is held in a generally upright position.

### BACKGROUND

Various devices for holding loose-leaf pages have been available. These include ring binder mechanisms in which rings having mating ring members are used to retain the loose-leaf pages. Ring binder mechanisms and other binder mechanisms are commonly used to hold loose-leaf pages in notebooks. A notebook typically includes a spine, a front cover hingedly secured to one side of the spine, and a back cover hingedly secured to an opposite side of the spine. A ring binder or other binder mechanism can be secured to the spine or one of the covers so loose-leaf pages can be retained in the notebook. The covers can be pivoted on the hinge connections to the spine to selectively cover or uncover any loose-leaf pages retained in the notebook. To view loose-leaf pages in the notebook as user typically places the back cover of the notebook flat on a work surface (e.g., the top surface of a desk, table, or the like) and moves the front cover to open the notebook and uncover any loose-leaf pages therein. Devices for supporting notebooks in an upright position are known. However, these can be difficult to manipulate and protrude outwardly from the notebook in an undesirable configuration.

### SUMMARY

One embodiment of the invention is a stand for supporting a structure for holding one or more pages. The stand has a mounting member for securing the stand to the structure. The mounting member has a mounting surface adapted to engage the structure. A support member is secured to the mounting member. The support member is moveable relative to the mounting member between a stowed position and a support position. The support member is disposed at a relatively larger angle relative to the mounting surface in the support position and at a relatively smaller angle relative to the mounting surface in the stowed position. The support member includes a pair of legs moveable between a stowed position and a support position, respectively. The legs define at least in part a base of the support member. The base has a relatively wider width when the legs are in their support positions and a relatively narrower width when the legs are in their stowed positions. Each of the legs is selectively reconfigurable between a first configuration in which the leg has a relatively shorter length and a second configuration in which the leg has a relatively longer length.

Another embodiment of the invention is a stand for supporting a structure for holding one or more pages. The stand has a mounting member for securing the stand to the structure. The mounting member has a mounting surface adapted to engage the structure. A support member is secured to the mounting member. The support member is moveable relative to the mounting member between a stowed position and a support position. The support member is selectively reconfigurable between a first configuration in which the support member is adapted to engage a work surface supporting the structure and a second configuration in which the support member is adapted to be secured to the structure to hold the structure in a configuration in which it can be supported upright on the work surface.

Still another embodiment of the invention is a notebook for holding one or more pages in combination with a stand for selectively supporting the notebook on a work surface. The notebook comprises a spine, a front cover, and a back cover. The spine is between the front and back covers and secured thereto in a manner that allows the front and back covers to move relative to the spine for selectively covering and uncovering the pages. The stand includes a support member secured to the notebook. The support member is moveable relative to the notebook between a stowed position and a support position. The support member is disposed at a relatively larger angle relative to the notebook in the support position and at a relatively smaller angle relative to the notebook in the stowed position. The support member has a pair of legs moveable between a stowed position and a support position, respectively. The legs define at least in part a base of the support member. The base has a relatively wider width when the legs are in their support positions and a relatively narrower width when the legs are in their stowed positions. Each of the legs is selectively reconfigurable between a first configuration in which the leg has a relatively shorter length and a second configuration in which the leg has a relatively longer length.

Another embodiment of the invention is a notebook for holding one or more pages in combination with a stand for selectively supporting the notebook on a work surface. The notebook has a spine, a front cover, and a back cover. The spine is between the front and back covers and secured thereto in a manner that allows the front and back covers to move relative to the spine for selectively covering and uncovering the pages. The stand has a support member secured to the spine. The support member is moveable relative to the spine between a stowed position and a support position. The support member is selectively reconfigurable between a first configuration in which the support member is adapted to engage a work surface supporting the notebook and a second configuration in which the support member is adapted to be secured to the front and back covers to retain the front and back covers in a desired orientation relative to the spine.

Other objects and features will in part be apparent and in part pointed out hereinafter.

### BRIEF DESCRIPTION OF THE DRAWINGS

FIG. 1 is a perspective of one embodiment of a stand of the present invention secured to a notebook;

FIG. 2 is another perspective of the stand shown in FIG. 1 without the notebook and from a vantage generally opposite that of FIG. 1;

FIG. 3 is a side view of the stand and notebook with the notebook opened and laid flat;

FIG. 4 is a top plan view of the stand;

FIG. 5 is an exploded perspective of the stand;

FIG. 6 is a side elevation of the stand and notebook, with a support member and legs thereof supporting the notebook on a work surface;

FIG. 7 is a perspective of the stand with the support member and legs thereof in their support positions from a vantage point looking up from the work surface;

FIG. 8 is a front elevation of the stand with the legs of the support member in their support positions and the support member in its stowed position;

FIGS. 9 and 10 are a perspectives of the stand with its support member and legs in their support positions from two different vantage points;

FIGS. 11-13 are perspectives illustrating a sequence in which a user moves the support member and legs from the stowed positions to their support positions using only a single hand;

FIG. 13A is an enlarged fragmentary perspective illustrating portions of a retaining system for retaining the support member and legs in their stowed positions;

FIGS. 13B-13C are schematic sections of the legs interacting with the mounting plate and retaining system as the legs approach their stowed positions;

FIG. 14 is a perspective illustrating a clip on an end of a mounting member of the stand being moved along the mounting member to secure the stand to a notebook;

FIG. 15 is a perspective showing the stand secured to a back cover of the notebook;

FIG. 16 is a side elevation of the stand and notebook, the notebook having a ring metal that has been secured thereto with the same fasteners used to secure the stand to the notebook;

FIG. 17 is a bottom perspective of another embodiment of a stand of the present invention in which a support member and legs thereof move freely between their support positions and stowed positions;

FIG. 18 is a fragmentary perspective of a portion of another embodiment of a stand of the present invention showing a pre-stressed spring clamp on one end of a mounting member;

FIG. 19 is a side elevation of the portion of the stand illustrated in FIG. 18;

FIG. 20 is a perspective of another embodiment of a stand of the present invention secured to a notebook;

FIG. 21 is a plan view of the stand shown in FIG. 20 with the legs in their stowed positions;

FIG. 22 is an exploded perspective of the stand shown in FIGS. 20-21;

FIG. 23 is a perspective of the stand shown in FIGS. 20-22 with the legs in their support positions and in a relatively shorter configuration;

FIG. 24 is a side elevation of the stand configured as shown in FIG. 23 and supporting a notebook on a work surface;

FIG. 25 is a perspective of the stand shown in FIGS. 20-24 with the legs in a relatively longer configuration;

FIG. 26 is a side elevation of the stand configured as shown in FIG. 25 and retaining the covers and spine of a notebook in a self-supporting configuration in which the bottoms of the notebook spine and covers are adapted to support the notebook on a work surface;

FIG. 27 is a plan view of the stand and notebook shown in FIG. 26;

FIG. 28 is a perspective of another embodiment of a stand of the present invention secured to a notebook;

FIG. 29 is a plan view of the stand shown in FIG. 28 with the legs in their stowed positions;

FIG. 30 is an exploded perspective of the stand shown in FIGS. 28-29;

FIG. 31 is a perspective of the stand shown in FIGS. 28-30 with the legs in their support positions and in a relatively shorter configuration;

FIG. 32 is a side elevation of the stand configured as shown in FIG. 31 and supporting a notebook on a work surface;

FIG. 33 is a perspective of the stand shown in FIGS. 28-32 with the legs in a relatively longer configuration;

FIG. 34 is a side elevation of the stand configured as shown in FIG. 33 and retaining the covers and spine of a notebook in a self-supporting configuration in which the bottoms of the notebook spine and covers are adapted to support the notebook on a work surface;

FIG. 35 is a plan view of the stand and notebook shown in FIG. 34; and

FIG. 36 is a perspective view of the stand and notebook shown in FIGS. 34-35.

Corresponding reference characters indicate corresponding parts throughout the drawings.

### DETAILED DESCRIPTION

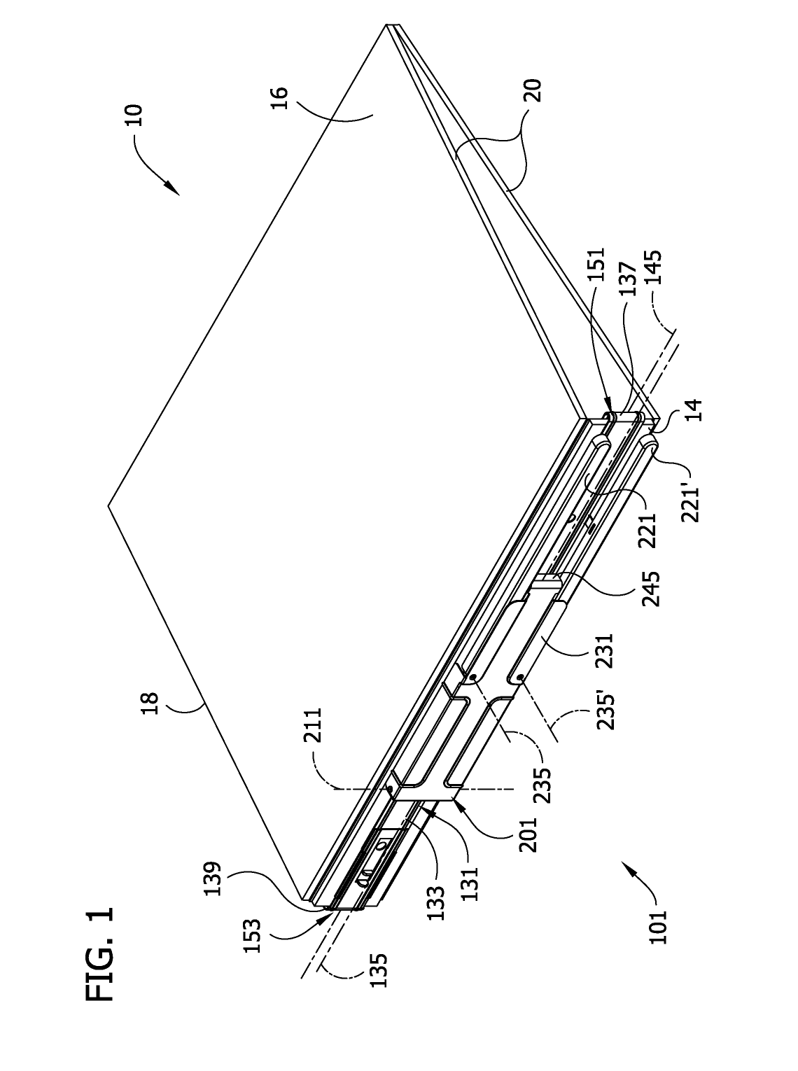

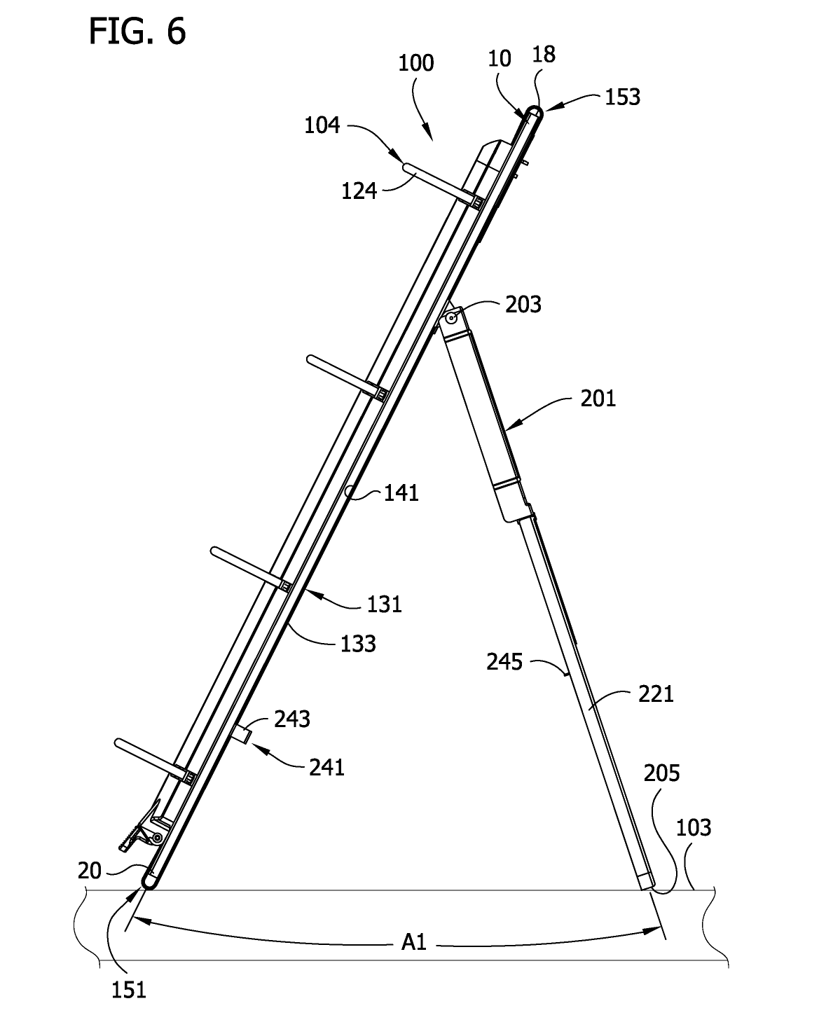

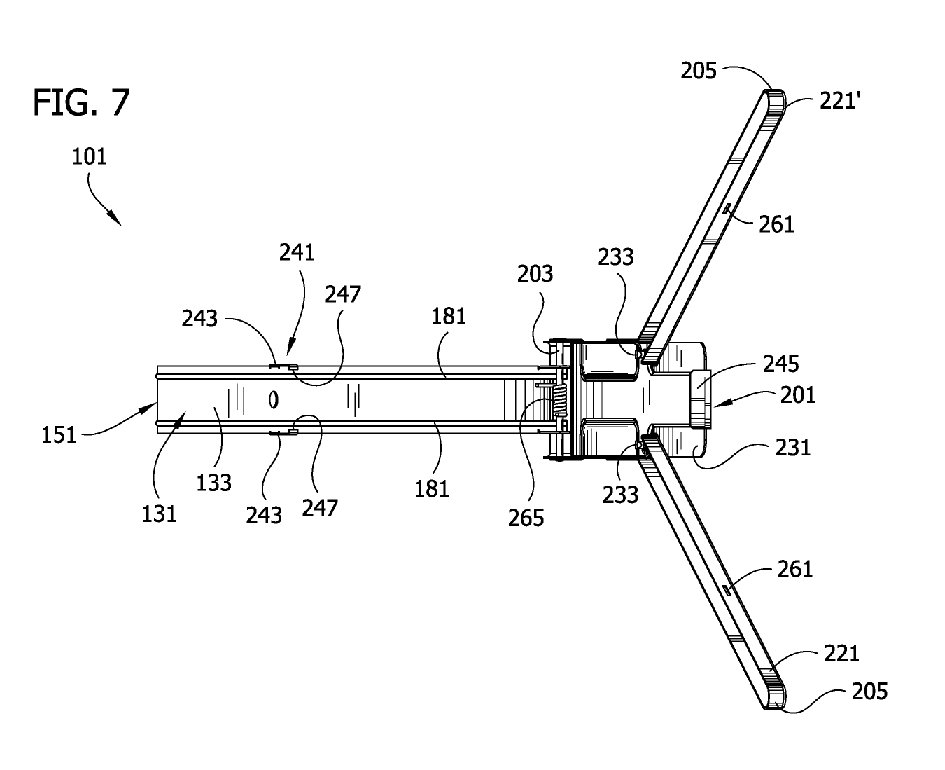

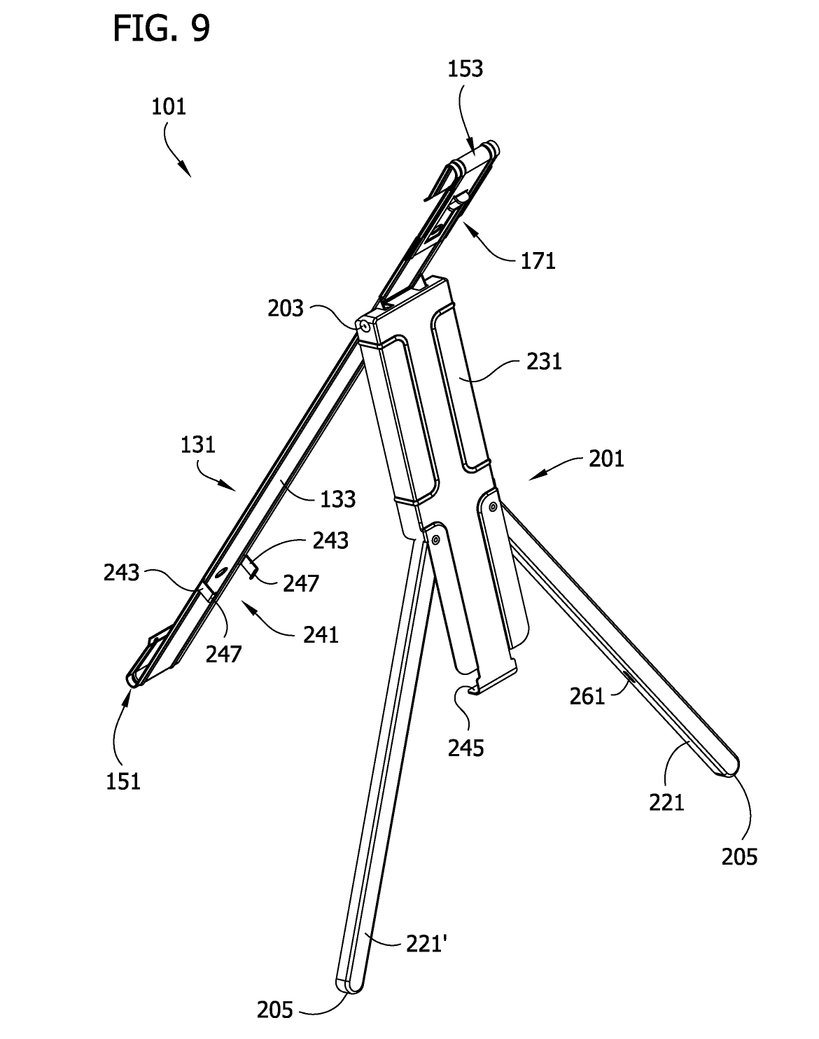

Referring to FIGS. 1-15, one embodiment of a stand of the present invention, generally designated 101, is illustrated secured to a notebook 10 (broadly, a “structure”) for holding loose-leaf pages. The stand 101 is operable to support at least part of the notebook 10 above a work surface 103, such as the top of a table, desk or the like. In FIG. 6, for example, the stand 101 holds the notebook 10 (a cover of which is seen edge-on in FIG. 6) in an inclined position in which the top edge margin 18 of the notebook is higher than the bottom edge margin 20 to facilitate viewing of loose-leaf pages (not shown) in the notebook in a generally upright position by a person without requiring either of the user's hands to hold the notebook.

The notebook 10 has a spine 14, a front cover 16 hingedly secured to one lateral side of the spine, and a back cover 12 hingedly secured to an opposite lateral side of the spine. A ring binder mechanism 100 is secured (e.g., by a set of rivets 113 or other suitable fasteners) to the back cover 12 adjacent the spine 14. The ring binder mechanism 100 could be mounted to the spine 14 or the front cover 16 instead of the back cover 12, as is generally known in the art. The ring binder mechanism 100 includes a plurality of rings 104, each of which is formed by a pair of ring members 124 that are moveable relative to one another between open and closed positions. The ring binder notebook 10 shown in the drawings is just one example of structure that is suitable for holding loose-leaf pages. It is possible to use other types of binder mechanisms to retain loose-leaf pages in the notebook within the invention. The stand 101 is also suitable for use with other structures such as file folders, hangable notebook files, clip boards, bound documents, books, and the like within the scope of the invention.

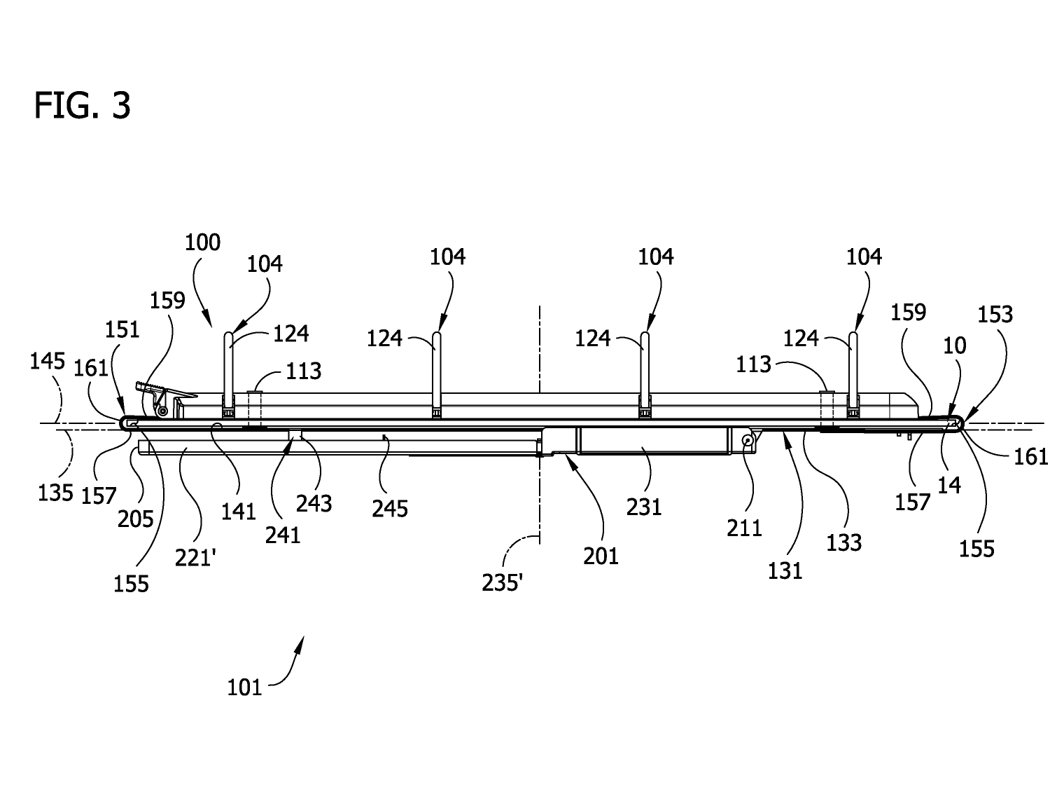

As illustrated in FIGS. 1 and 3, the stand 101 has a mounting member 131 for securing the stand to the notebook 10. In this embodiment, the mounting member 131 includes an elongate plate 133 and has a longitudinal axis 135 extending generally between opposite longitudinal ends 137, 139 of the plate. The back of the plate 133 defines a mounting surface 141 adapted to engage the notebook 10 while the stand 101 is secured thereto. When the mounting member 131 is secured to the notebook 10 as shown in FIGS. 1 and 3, the longitudinal axis 135 of the mounting member is substantially parallel to a longitudinal axis 145 of the notebook spine 14. The mounting member 131 is secured to the notebook 10 so the mounting member remains fixed relative to the notebook during use of the stand 101. That is, use of the stand 101 does not require movement of the mounting member 131 relative to the notebook.

In this embodiment, the mounting member 131 is secured to the notebook 10 for nondestructive removal of the stand 101 from the notebook. The mounting member 131 has clips 151, 153 (broadly “connector portions”) at its opposing longitudinal ends 137, 139 for releasably securing the mounting member to the notebook 10. Each clip 151, 153 defines a channel 155 for receiving an edge margin of the notebook 10 (e.g., the top 18 or bottom 20 of the notebook) between two opposing retaining members 157, 159 joined by a resilient hook portion 161 of the clip. The hook portion 161 is configured to extend around the edge margin of the notebook 10 from one side to the other, as illustrated in FIG. 3. The retaining members 157, 159 are suitably spaced from one another a distance that is slightly less than the thickness of the cover/spine of the notebook 10 so that the notebook is clamped between the retaining members by elastic restoration forces of the resilient hook portion 161 to help hold the mounting member 131 securely to the notebook.

One clip 151 in this embodiment is integral with the elongate plate 133. The clip 151 may be made by bending the elongate plate 133 back on itself so that a portion of the plate that was originally longitudinally inward of the original end of the plate forms the hook portion 161 and thereby becomes the new longitudinal end 137 of the elongate plate. When the clip 151 is made this way, the retaining members 157, 159 are formed by segments of the plate 133 that were originally longitudinally outward and longitudinally inward, respectively, of the portion of the plate that becomes the hook portion 161. In one embodiment of the invention (not shown) the other clip is made in the same way. The longitudinal spacing between the clips in this embodiment may be fixed, in which case the mounting member can be secured to the notebook 10 by sliding the clips parallel to the edge margins of the notebook that are received in the channels (e.g., starting at the corners of one of the covers and sliding the clips along the top 18 and bottom 20 toward the spine 14) to position the clips on or adjacent the spine.

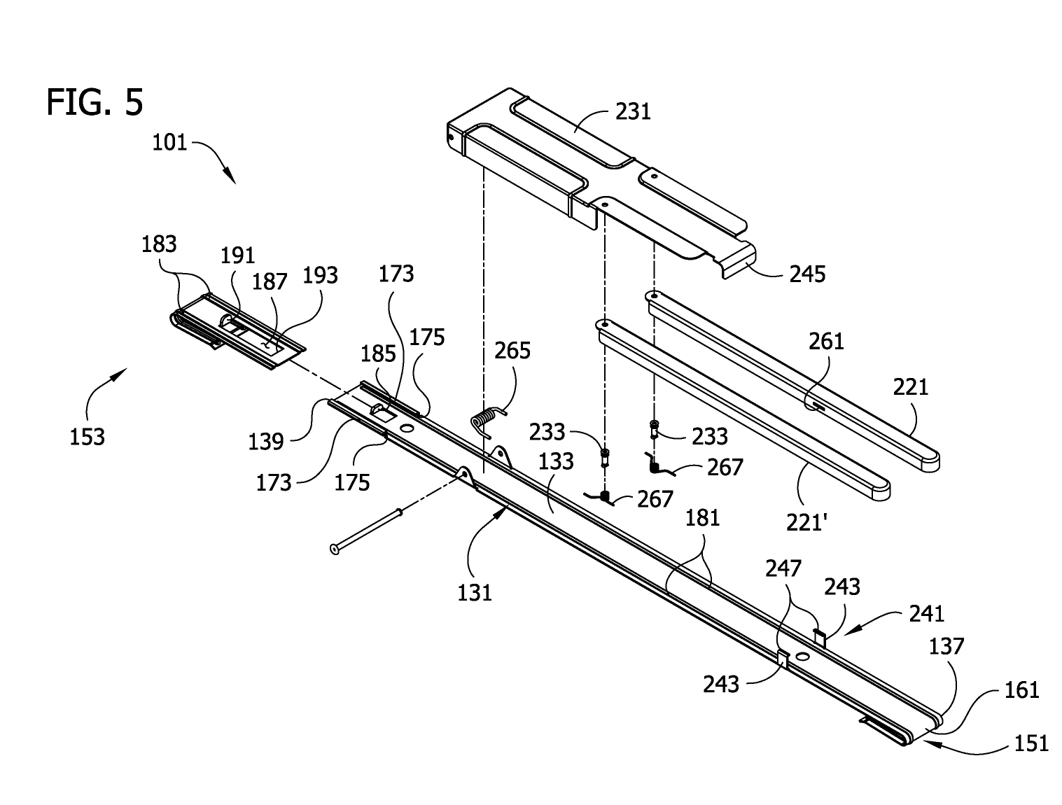

In the illustrated embodiment, the mounting member 131 defines a rail 171 extending longitudinally to adjacent the end 139 of the plate 133 opposite the integral clip 151. The other clip 153 is made separate from the elongate plate 133 and slidably mounted on the rail 171 to allow adjustment to the longitudinal spacing between the hook portions 161 of the clips 151, 153. The clip 153 is made by bending a plate 163 having about the same width as the width of the elongate plate 133 to form the resilient hook portion 161 between two retaining members 157, 159. As best illustrated in FIG. 5, the rail 171 is defined by sides 173 of the elongate plate 133 that at one end of the rail are turned upward and inward to define laterally-inward facing channels 175.

Lateral edge margins of one of the retaining members 157 of the non-integral clip 153 are received in the channels 175 of the rail 171. The elongate plate 133 has one or more longitudinally extending ribs 181 (e.g., two ribs as illustrated). The retaining member 157 that is received in the channels 175 of the rail also has ribs 183 in conformal relation with the ribs 181 on the plate. As illustrated in FIG. 5, the ribs 181 on the mounting plate 133 are adjacent the lateral sides thereof. Not only do the ribs 181, 183 add strength to the elongate plate 133 and clip 153, they also help guide movement of the clip along the rail 171. The clip 153 is retained longitudinally on the rail 171 by an upturned tab 185 on the elongate plate 133, which is received in a longitudinally extending slot 187 in the retaining member 157 of the clip 153. The upturned tab 185 moves in the slot 187 as the clip 153 slides relative to the mounting member 131. The tab 185 engages ends 191, 193 of the slot 187 to limit movement of the clip 153 on the rail 171 to prevent separation of the clip from the mounting member 131 and to prevent over tightening of clips 151, 153, which could damage the notebook 10. It is understood that both clips of the mounting member can be made separately and mounted for movement longitudinally on the elongate plate, if desired, within the scope of the invention.

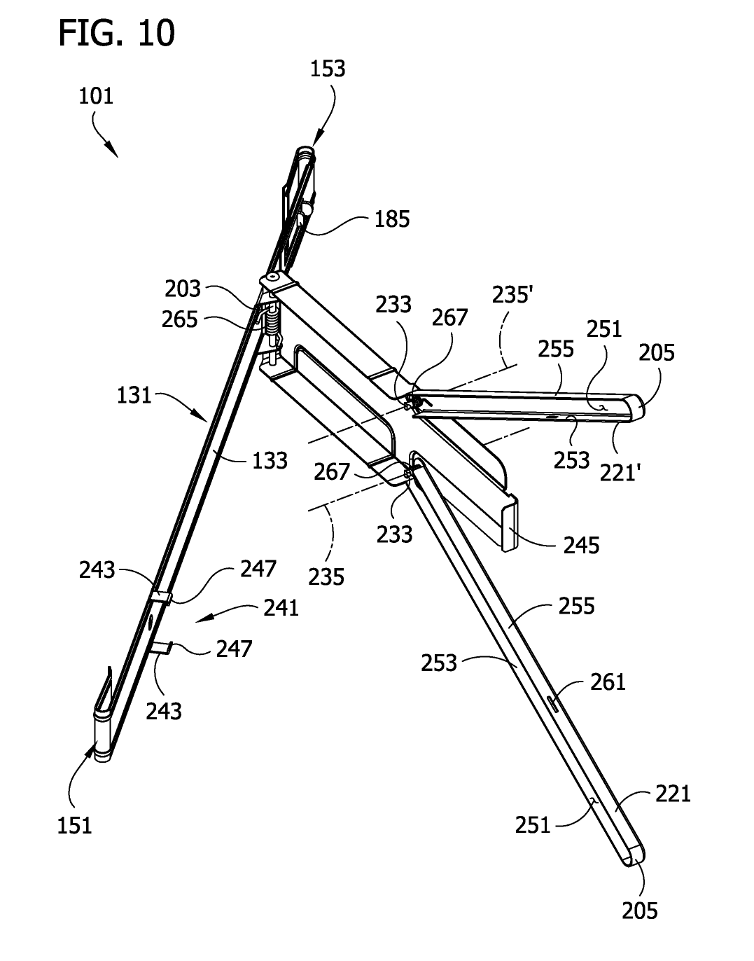

A support member 201 is secured to the mounting member 131 and moveable relative to the mounting member 131 between a stowed position (FIG. 1) and a support position (FIGS. 6-10). As illustrated in FIG. 10, the support member 201 is secured to the mounting member 131 by a hinge connection 203 at one end of the support member. In this embodiment, the support member 201 is pivotally moveable on the hinge 203 between its stowed position in which a base 205 of the support member 201 opposite the hinge connection is adjacent the elongate plate 133 of the mounting member 131 and a support position in which the base is spaced from the mounting member. The support member 201 pivots relative to the mounting member 131 on a pivot axis 211 that is substantially perpendicular to the longitudinal axis 135 of the mounting member and the longitudinal axis 145 of the spine 14 of the notebook 10. As illustrated in FIGS. 3 and 6, the support member 201 is disposed at a relatively larger angle A1 (FIG. 6) relative to the mounting surface 141 in the support position and at a relatively smaller angle relative to the mounting surface in the stowed position. In FIG. 3, for instance, the support member 201 is generally parallel with (i.e., disposed at an angle of about zero relative to) the mounting surface 141.

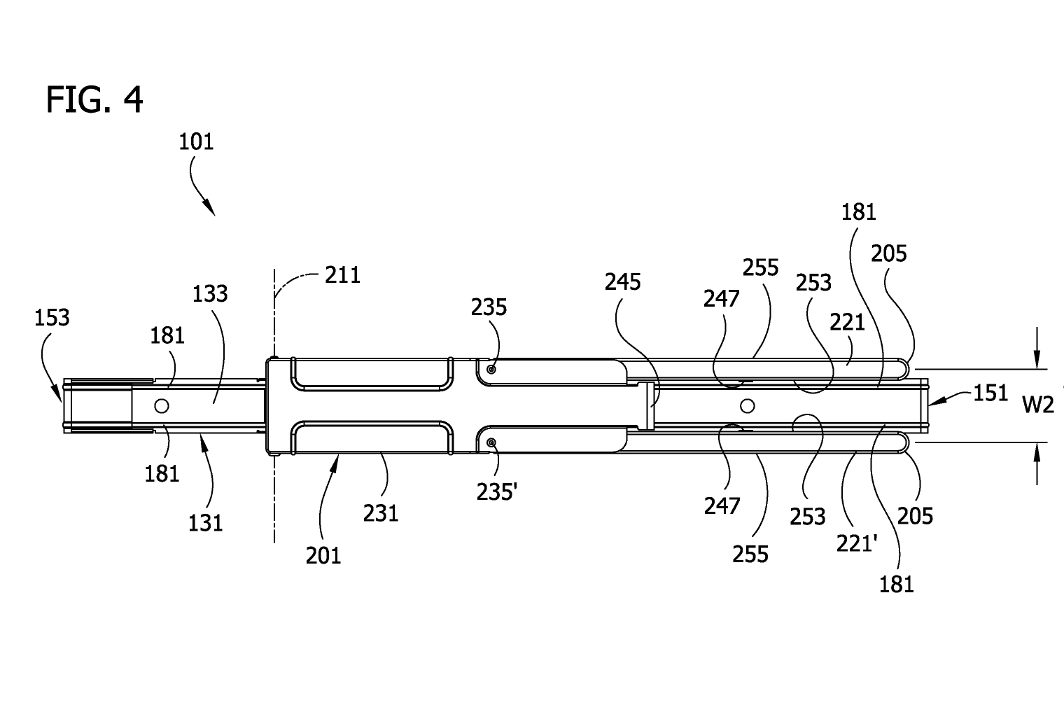

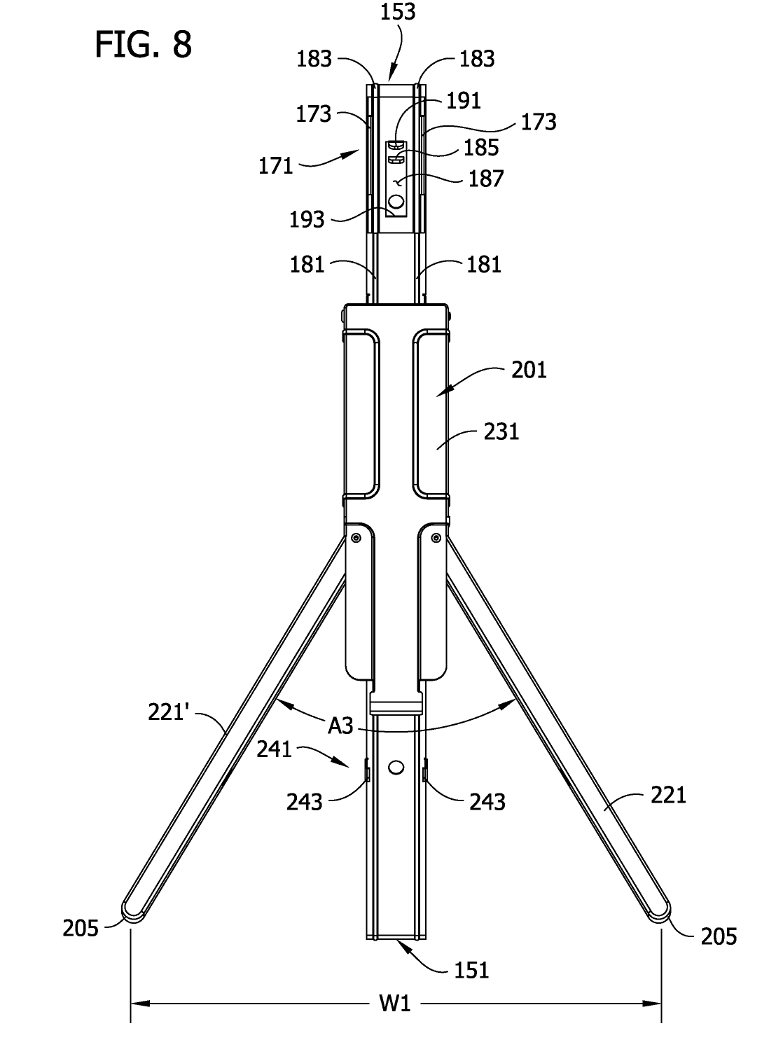

In use, the base 205 of the support member 201 engages the work surface 103 while the support member is in the support position to hold the notebook 10 in the generally upright inclined position. The base 205 is defined in part by at least one moveable leg 221 that can be moved between a stowed position and a support position. The base 205 has a relatively wider width W1 (FIG. 8) when the leg 221 is in the support position and a relatively narrower width W2 (FIG. 4) when the leg is in the stowed position. Accordingly, when the leg 221 is in its support position, the base 205 of the support member has a larger footprint, thereby providing additional stability to the stand 101. The embodiment illustrated in the drawings has two legs 221, 221′ that are moveable between stowed and support positions. One of the two legs 221 is moveable from its stowed position outward in a first direction to its support position. The other leg 221′ is moveable from its stowed position outward in a second direction generally opposite the first direction to its support position. The base 205 of this embodiment has a width W2 in the range of about 2.5 to 4 cm when the legs are in their stowed position. For example, the width W2 of the base when the legs 221, 221′ are in their stowed position may be about equal to the width of the spine 14 of a notebook 10 having rings 104 that are about 3 cm in diameter. When the legs 221, 221′ are in their support position, the base 205 in one embodiment may have a width W1 in the range of about 88 to 242 mm. The number of legs may be other than described herein within the scope of the present invention. The base 205 further includes (in addition to legs 221, 221′) in the illustrated embodiment the distal end of the support member 201 and the bottom of the mounting member 131. However, it is to be understood that a base may be defined by any two of these members, or by additional members within the scope of the present invention.

As best illustrated in FIGS. 5 and 10, the legs 221, 221′ are secured to a bracket 231 of the support member 201 for pivotal movement of the legs relative to the bracket between their stowed and support positions. In the illustrated embodiment, for example, each of the legs 221, 221′ is connected to the bracket 231 at one end by a pin connection 233. The pin connections 233 allow the legs 221, 221′ to pivot on axes 235, 235′ that are substantially perpendicular to the pivot axis 211 of the support member 201 relative to the mounting member 131 on the hinge 203. The legs 221, 221′ pivot in opposite directions when they move from their stowed positions to their support positions. In their stowed position, the legs 221, 221′ are spaced laterally from one another and are generally parallel to one another. When the legs 221, 221′ are in their support positions, they form an angle A3 (FIG. 8) that is suitably in the range of about 30 to about 90 degrees, and more suitably in the range of about 45 to about 65 degrees. The legs 221, 221′ are about equal in length and longer than the bracket 231 of the support member 201. For example, each of the legs 221, 221′ of the illustrated embodiment has a length that is about one half the length of the elongate plate 133 of the mounting member 131 while the bracket 231 has a length that is only about one quarter to one third the length of the elongate plate.

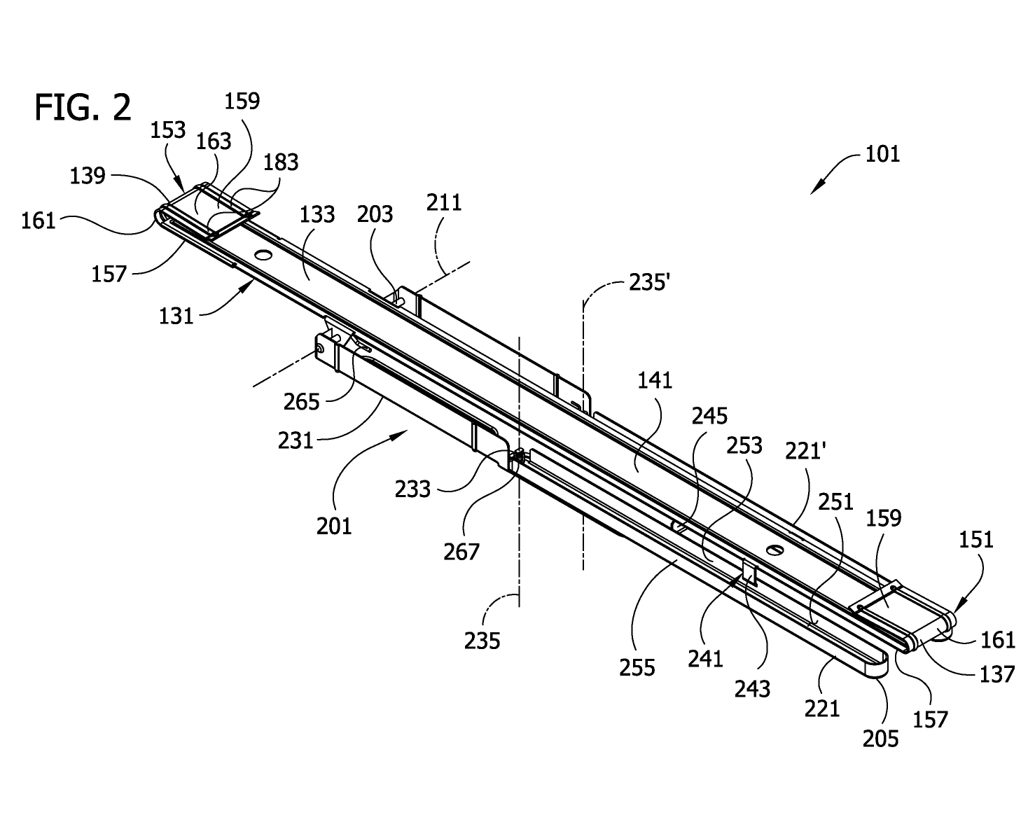

As best shown in FIGS. 2, 5, 9, and 10, the stand 101 includes a retaining system 241 engageable with the support member 201 to releasably hold the legs 221, 221′ and the support member in their stowed positions. In the illustrated embodiment, the retaining system 241 includes a pair of L-shaped fingers 243 (broadly, “retaining members”) extending upwardly and inwardly from lateral sides of the elongate plate 133 of the mounting member 131. The fingers 243 are spaced longitudinally from the hinge connection 203 to engage the support member 201, and in this embodiment the legs 221, 221′, near the base 205 of the support member. The fingers 243 are integral with the elongate plate 133 and may be made by bending laterally extending tabs on the plate up and inward.

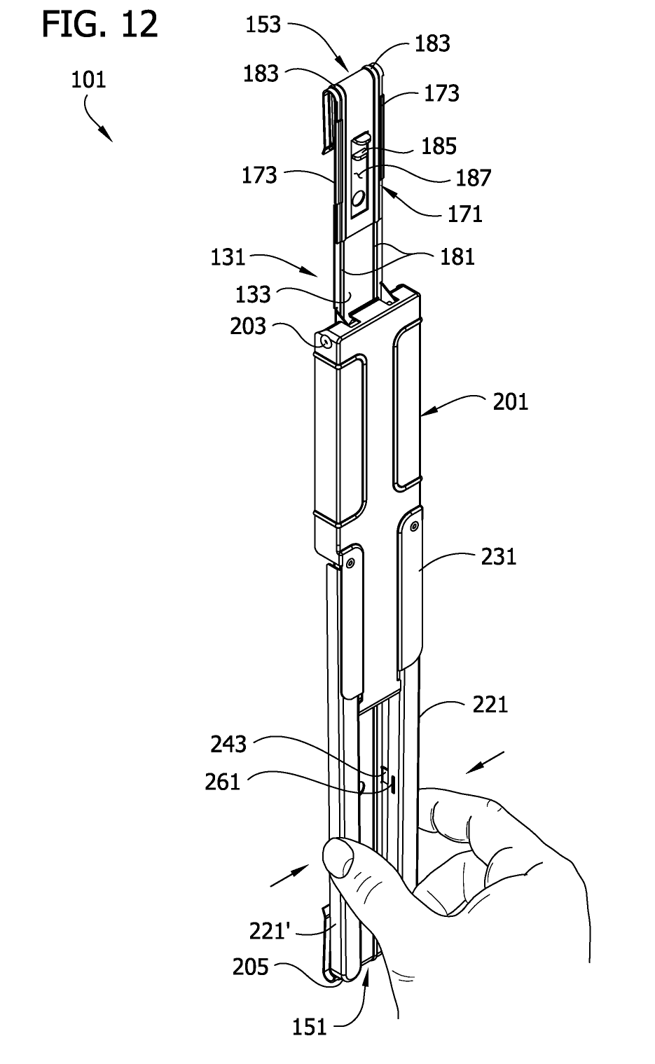

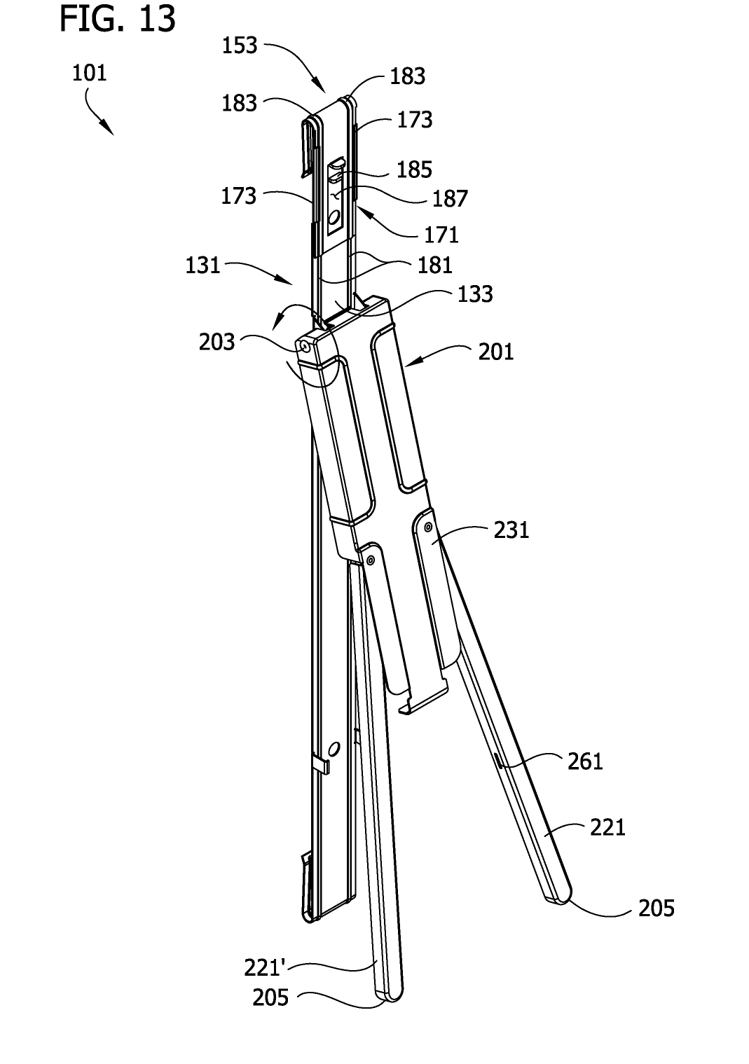

Referring to FIGS. 1, 4, and 5, the bracket 231 includes a spacer 245 positioned between the legs 221, 221′ to limit pivoting movement of the legs toward one another. The spacer 245 allows the legs 221, 221′ to be pivoted slightly inward from their stowed positions (e.g., as shown in FIG. 12). In the embodiment shown in the drawings, the spacer 245 is integral with the bracket 231. For example, the spacer 245 is suitably constructed by bending a generally rectangular tab on the bracket 231 downward to form the spacer. Each of the legs 221, 221′ is suitably constructed to define an open channel 251 (FIG. 10) facing the mounting member 131 between lateral sides 253, 255 of the legs, thereby allowing the fingers 243 to be received in the channel when the support member 201 is moved to its stowed position while the legs are in a rotational orientation in which the channels are aligned with the fingers. Each of the legs 221, 221′ has an opening 261 (e.g., an elongate slot) in its laterally inward facing side 253 for receiving the end 247 of the respective finger 243 after the fingers have been received in the channels 251 and the legs pivoted outward to their stowed positions. It is understood that other retaining systems, including various clips and/or snap-type retaining devices can be used within the scope of the invention.

Referring to FIG. 10, this embodiment of a stand 101 includes a torsion spring 265 (broadly, “a biasing member”) positioned to urge the support member 201 to pivot away from the mounting member 131 and thereby move toward its support position. The stand 101 also includes torsion springs 267 (broadly, biasing members) positioned to urge the legs 221, 221′ to pivot outward relative to one another and thereby to move toward their support positions. Although two separate torsion springs 267 (one for each of the legs 221, 221′) are used in the illustrated embodiment, it is understood that a single biasing member can be used to urge both legs to move toward their support positions. When the support member 201 and legs 221, 221′ are in their stowed positions, the retaining system 241 holds them in their stowed position and prevents the biasing members 265, 267 from moving them toward their support positions. Either or both of the biasing members 265, 267 may be omitted within the scope of the invention. The stand 101 is suitably adapted so that a user is able to move the support member 201 and legs 221, 221′ between their stowed and support positions with a single hand, as will be described in greater detail below.

In the illustrated embodiment, the spacer 245 is sized and positioned to allow the legs 221, 211′ to pivot inward toward one another far enough so that the ribs 181 are at least partially received in the channels 251 in the legs 221, 221′ when the base 205 of the support member 201 is adjacent the mounting member 131 and the laterally inward sides 253 of the legs are engaged with the spacer. In this embodiment, the laterally inward sides 253 of the legs 221, 221′ engage the ribs 181 and slide up to the crests thereof as the legs move from their inward-most position to their stowed positions. This helps the ends 247 of the fingers 243 align with the openings 261 in the sides 253 of the legs 221, 221′. Also, when a user holds the legs 221, 221′ in a manner that allows the biasing members 267 to move the legs from their inward-most positions to their stowed positions, a tactile sensation is produced by the sliding of the laterally inward sides 253 of the legs up to the crest of the ribs 181. A user can use this tactile sensation as an indication that the legs 221, 221′ have successfully engaged the retaining system 241 so that the legs and support member 201 will be held in their stowed positions upon release of the support member (e.g., release of the legs thereof) by the user's hand.

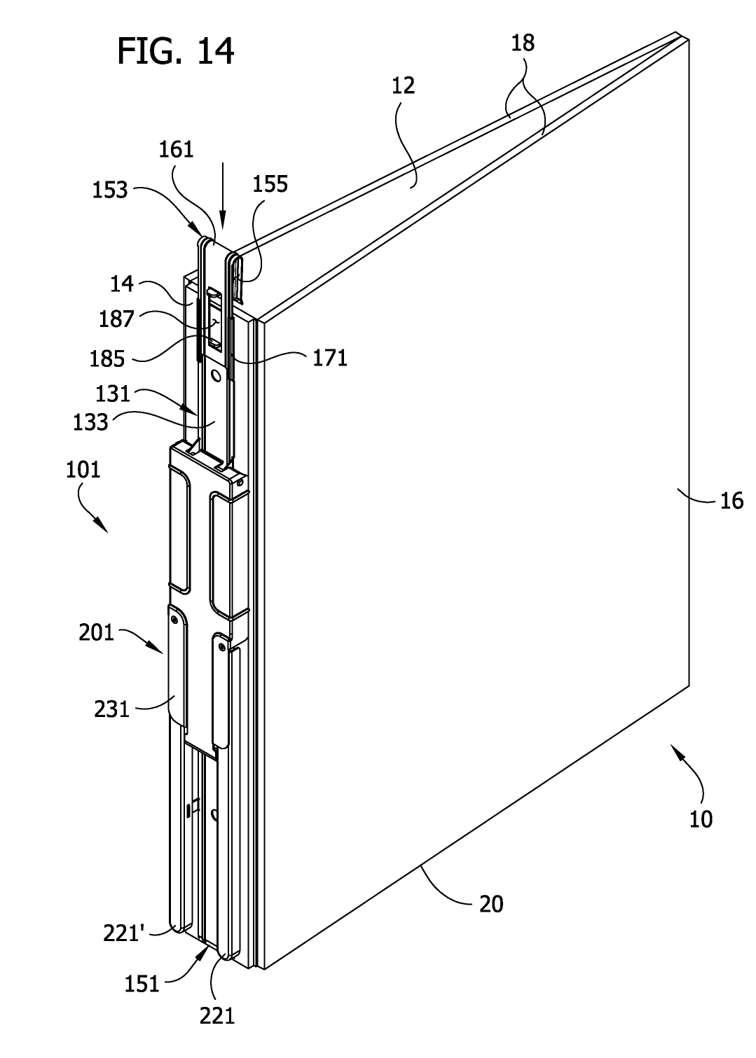

The stand 101 may be sold separately from the structure(s) it will support, but the notebook 10 or other structure may be sold together with the stand. To secure the stand 101 to a notebook 10, a user positions the clips 151, 153 of the mounting member 131 so the hook portions 161 thereof engage lateral edge margins of the notebook 10 (e.g., the top 18 and bottom 20). For example, the user can move the slidable clip 153 on the rail 171 to an extended position (FIG. 14) to increase the longitudinal distance between the hook portions 161 of the clips 151, 153. Then the user places the mounting surface close to the spine 14 (or one of the covers 12, 16) and slides the inner retaining member 159 of the integrally formed clip 151 up along the inner surface of the spine 14 (or cover) so that the bottom 20 of the notebook is received in the channel 155 between the two retaining members 157, 159. Then, by sliding the slidable clip 153 down along the rail (as indicted by the arrow in FIG. 14), the user can slide the inner retaining member 159 of the slidable clip 153 along the inner surface of the spine (or cover) so that the top 18 of the notebook is received in the channel 155 of the slidable clip, thereby securing the stand 101 to the notebook.

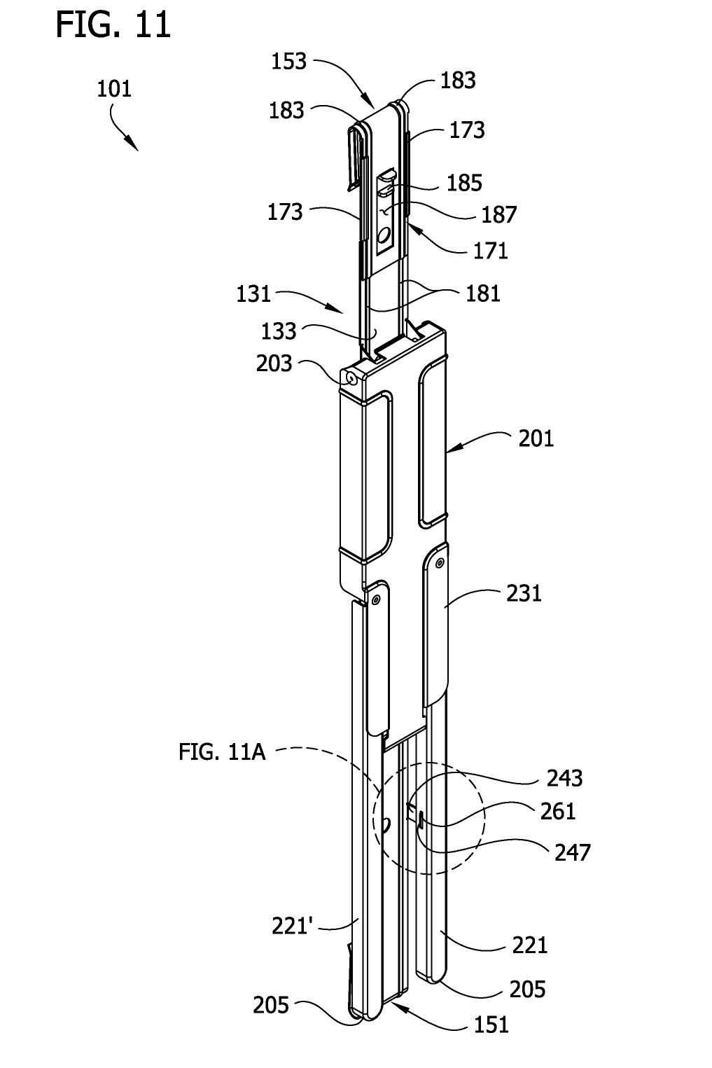

The support member 201 and legs 221, 221′ are typically in their stowed positions when the stand is not in use. A user can ready the stand 101 for use in supporting the notebook 10 using only a single hand. As illustrated in FIGS. 11-13, for example, a user can release the legs 221, 221′ from the retaining system 241 by squeezing the legs 221, 221′ toward one another (e.g., using the fingers of only one hand as illustrated in FIG. 12) against the biasing force provided by the biasing members 267. When the legs 221, 221′ have rotated inward far so the openings 261 of the legs are laterally inward of the ends 247 of the fingers 243, the user can move (or allow the biasing member 265 to move) the support member 201 toward its support position, thereby disengaging the legs from the retaining system 241. Then the user puts the base 205 of the support member and the bottom 20 of the notebook 10 and/or the end 137 of the mounting member 131 on the work surface (e.g., as shown in FIG. 6) so the stand 101 supports the notebook in a position that facilitates viewing of loose-leaf pages in the notebook by the user. The mounting member 131 remains fixed relative to the notebook 10 during movement of the support member 201 and the legs 221, 221′ between their stowed and support positions and while the stand 101 is used to support the notebook.

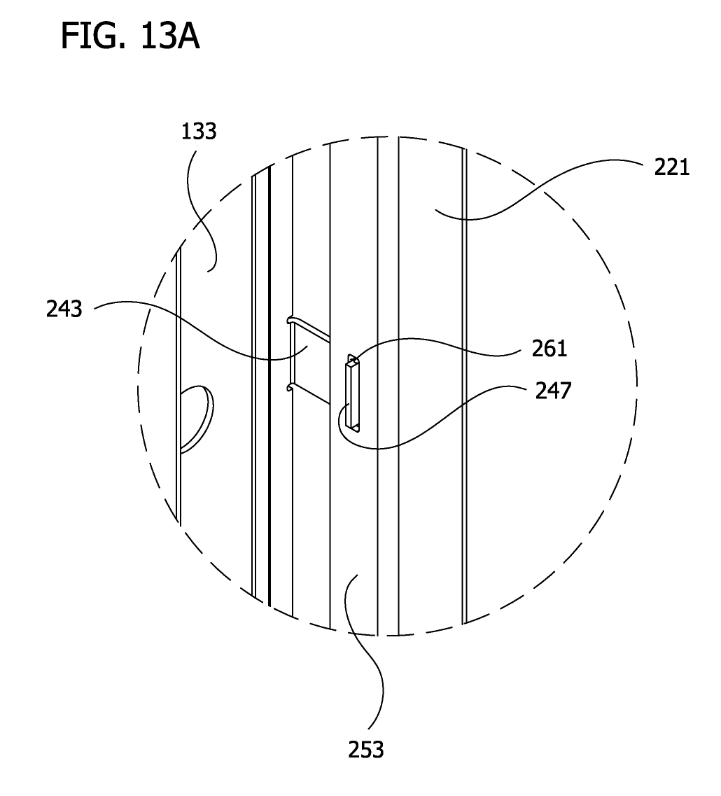

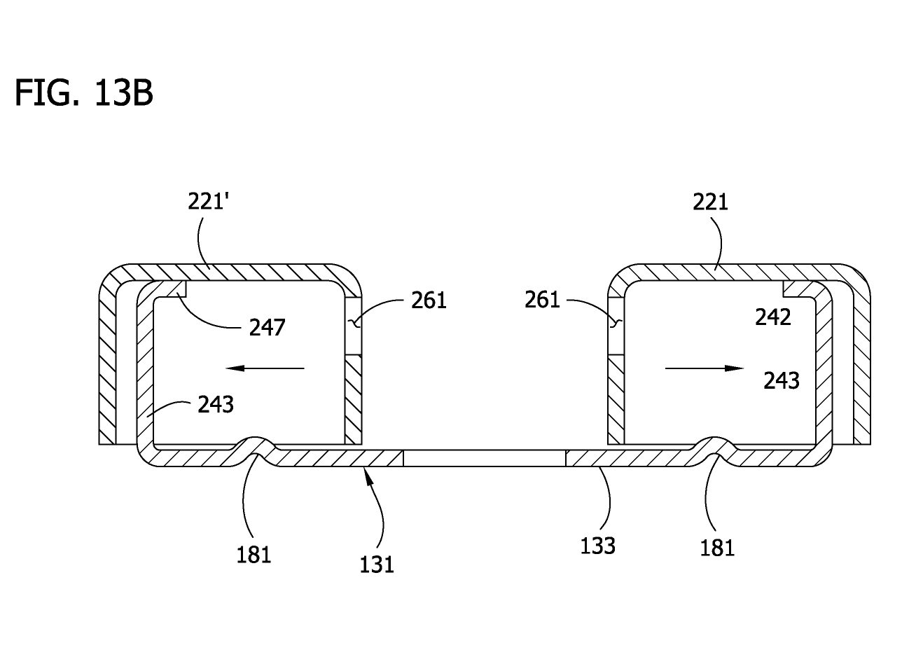

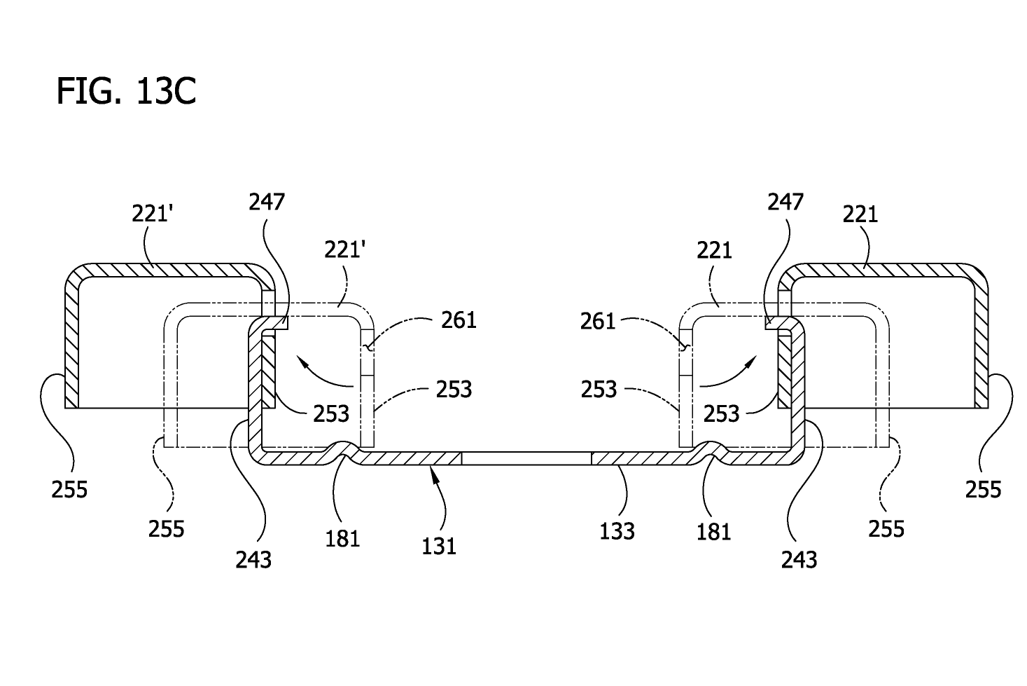

When the user is done viewing the loose-leaf pages, he or she can return the support member 201 and legs 221, 221′ to their support positions using only a single hand. In the illustrated embodiment, for example, the user can grip the legs 221, 221′ (e.g., adjacent the bracket 231) between the fingers of one hand and squeeze them together to pivot the legs inward against the urging of the biasing members 267 until they contact the spacer 245. While holding the legs 221, 221′ in contact with the spacer 245, the user can pivot the support member 201 so that the base 205 thereof moves toward the mounting member 131 until the support member 201 contacts the mounting member. In the embodiment illustrated in FIG. 13B, for instance, the user pivots the support member until the legs 221, 221′ contact the fingers 243 of the retaining system 241. While holding the support member 201 in contact with the mounting member 131, the user can move (or allow the biasing members 267 to move) the legs 221, 221′ pivotally outward a small amount so that the ends 247 of the fingers 243 are received in the openings 261 in the sides 253 of the legs. As the legs 221, 221′ pivot outward to their stowed positions, their inward facing sides 253 engage the ribs 181 on the mounting plate 133, which causes the support member 201 to pivot very slightly relative to the mounting plate 133 so the sides of the legs can clear the crests of the ribs. The pivoting movement produced by interaction of the legs 221, 221′ with the ribs 181 aligns the ends 247 of the fingers 243 with the openings 261 that they are received in when the legs are in their stowed position, as shown in FIG. 13C. The slight pivoting reaction of the support member 201 in response to the engagement of the legs 221, 221′ with the ribs 181 is perceived by the user as an indication that the support member and legs have been successfully moved to their stowed positions where they will be retained by the retaining system 241. The legs 221, 221′ and support member 201 are releasably held in their stowed positions by engagement of the fingers 243 of the retaining system 241 with the legs until the processes of readying the stand 101 for use is repeated by the same or another user.

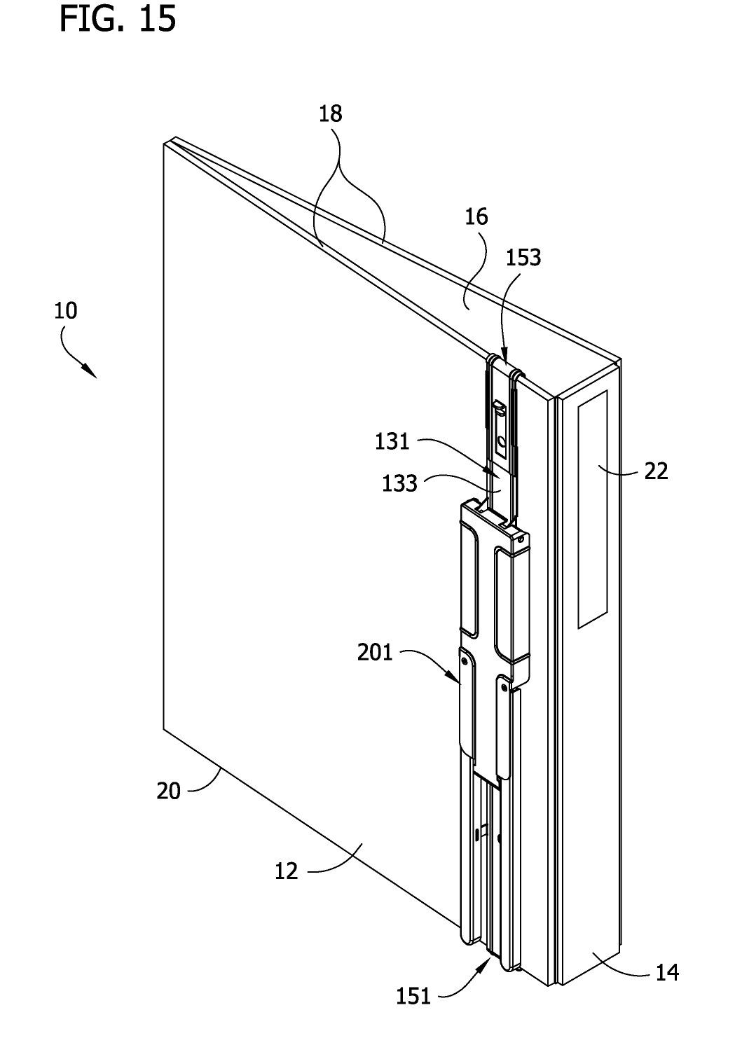

The stand 101 may remain secured to the notebook 10 for an indefinite period of time between uses. In some cases, it may be desirable to store the notebook 10 and stand 101 on a bookshelf or in another storage system in which substantially only the spine 14 of the notebook can be viewed without handling the notebook. When a notebook 10 is stored in such a manner, it is conventional to put a label 22 (FIG. 15) on the spine 14 so the contents of the notebook can be identified just by looking at the spine. In the embodiment shown in the drawings, the mounting member 131 is selectively moveable by a user between a position (FIG. 1) in which the mounting member secures the stand 101 to the notebook 10 so the mounting surface 141 is adjacent the spine 14 and a position (FIG. 15) in which the mounting member secures the stand to the notebook so the mounting surface is adjacent one of the covers 12, 16 (e.g., in proximity to the spine). Thus, a user can selectively move the stand 101 relative to the notebook 10 from a position in which the stand is secured to the notebook and obstructs viewing of the label 22 on the spine 14 to a position in which the stand is secured to the notebook and viewing of the label is not obstructed by the stand. When moving the stand 101 illustrated in the drawings away from the spine 14, a user can open the notebook 10 and slide the clips 151, 153 along the top 18 and bottom 20 edges away from the spine or extend the clip 153 on the rail 171 to disengage the clips from the notebook and then secure the stand to one of the notebook covers in a manner analogous to way the stand is secured to the spine, as described above and illustrated in FIG. 14.

In another embodiment of the invention, the stand 101 may be initially secured to the notebook 10 so the mounting member is secured to one of the covers 12, 16 (e.g., adjacent the spine 14) so the stand is already in a position in which it does not obstruct viewing of the label 22 when it comes time to put the notebook in storage (FIG. 15). In this embodiment, the user does not need to move the stand 101 to store the notebook 101 along with the stand in a manner that allows viewing of the label without obstruction by the stand. In yet another embodiment of the invention, the stand 101 is simply removed from the notebook 10 (e.g., to make the stand available for use with another notebook or other structure that retains loose-leaf pages) before the notebook is placed in storage, thereby leaving viewing of the label unobstructed by the stand.

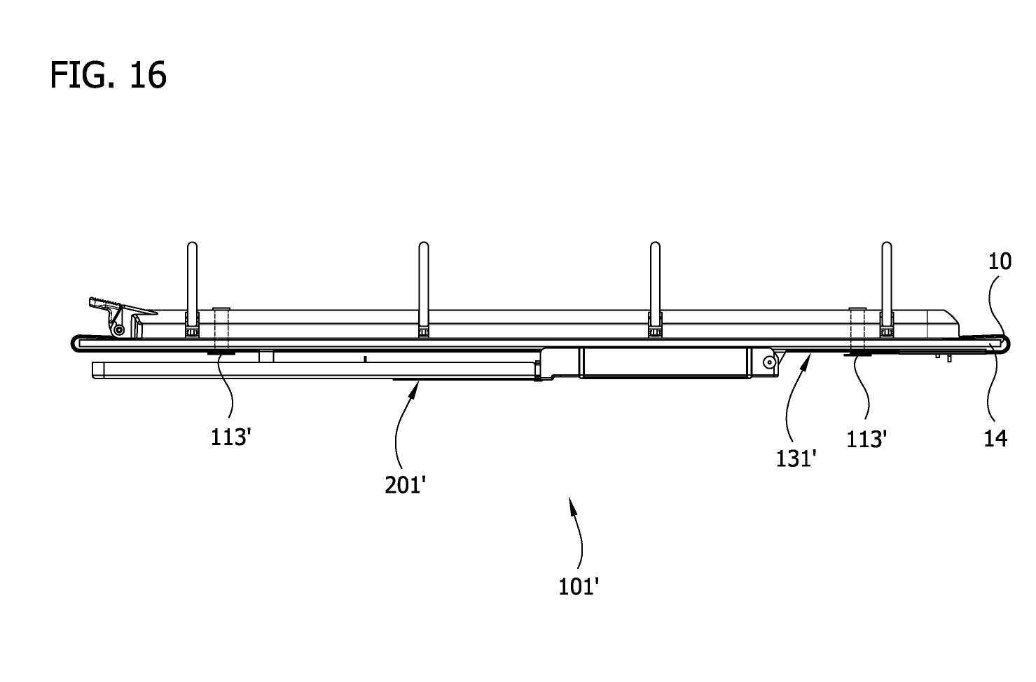

Another embodiment of a stand 101′ is illustrated in FIG. 16. Except as noted, this embodiment of the stand is substantially the same as the stand 101 described above. In this embodiment, the mounting member 131′ is fixedly secured to the notebook 10. In particular, the mounting member 131′ is secured to the notebook 10 in registration with the ring binder mechanism 100 using the same fasteners (e.g., rivets 113′) that are used to secure the ring binder mechanism to the notebook. Although the stand 101′ in FIG. 16 is secured to the spine 14 of the notebook, it is understood that the stand 101′ and ring binder mechanism 100 can be secured in registration with one another to either of the covers 12, 16 (e.g., adjacent the spine). The stands 101, 101′ operate in the same way except that the stand 101′ illustrated in FIG. 16 is not intended to be removed from the notebook 10.

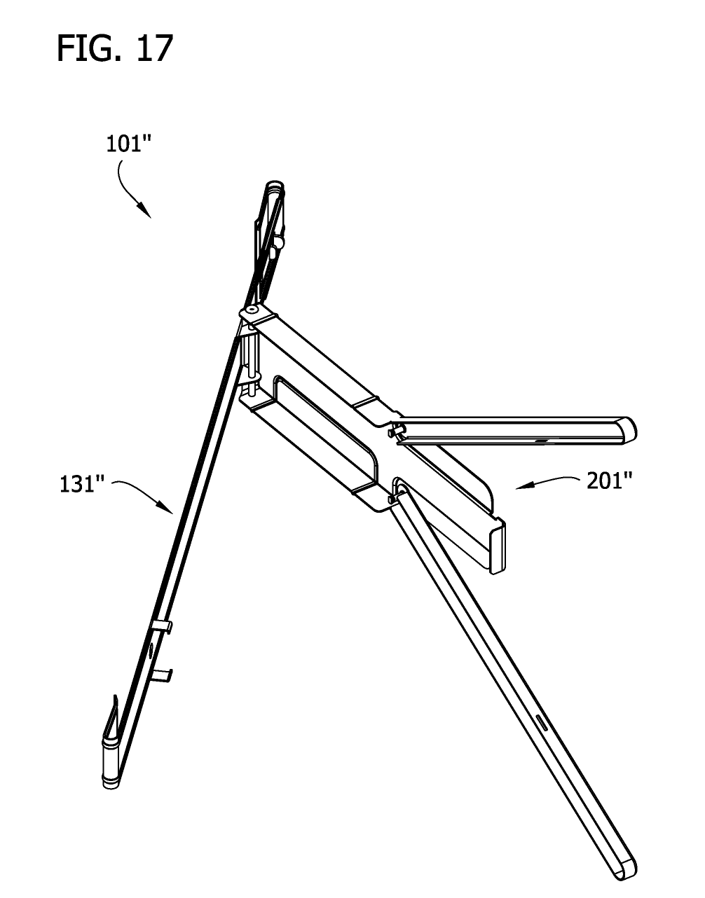

Still another embodiment of a stand 101″ is illustrated in FIG. 17 and is substantially the same as the stand 101 described above except that biasing members 265, 267 are omitted in this embodiment. The stand 101″ operates in substantially the same manner described above except for the fact that a user can not rely on biasing forces from the biasing members 265, 267 when readying the stand for use in supporting the notebook 10.

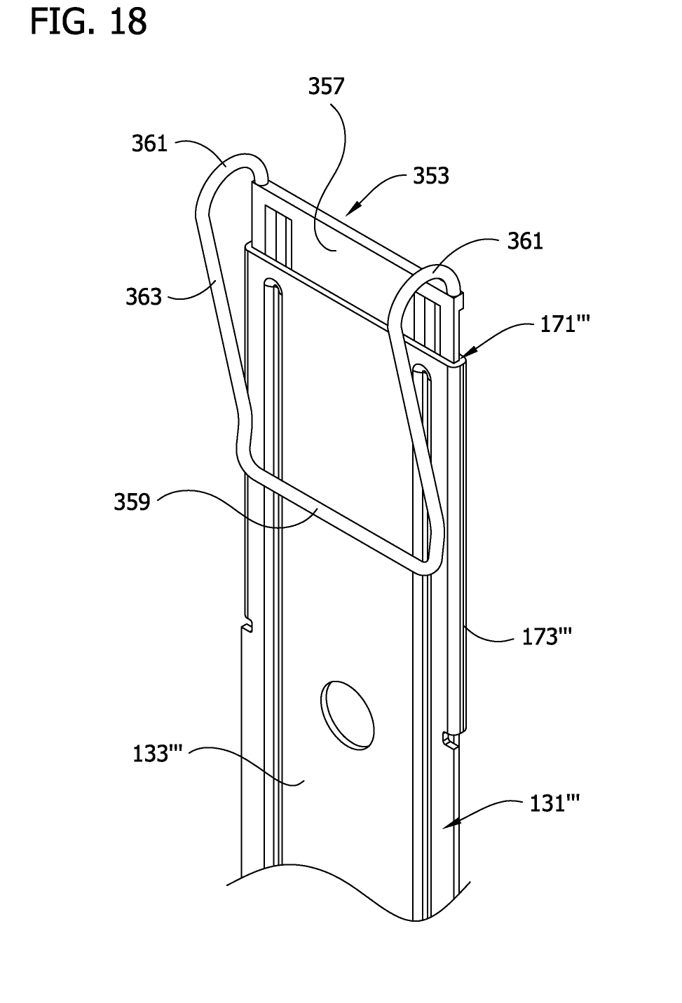

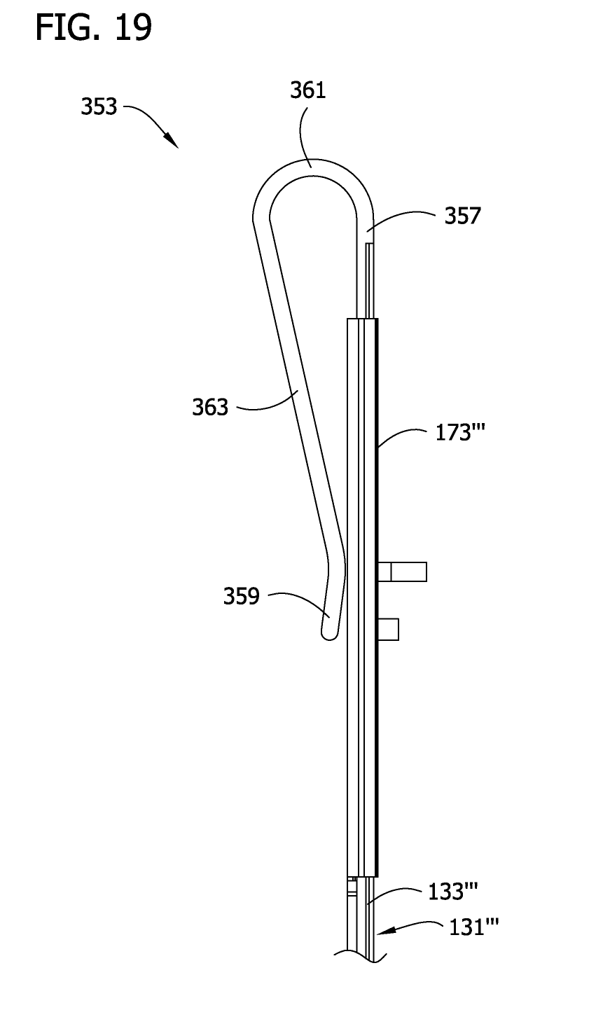

FIGS. 18 and 19 illustrate a portion of yet another embodiment of a stand of the present invention, which is substantially the same as the stand 101 described above, except as noted. In this embodiment, at least one pre-stressed spring clip 353 is slidably mounted on the rail 171′″ at the end of the mounting member 131′″. In the illustrated embodiment, the spring clip 353 includes a plate 357 that is similar to the plate 157 in that it is received on the rail 171′″ between the upturned sides 173′″ and is shaped to conform to the mounting plate 133′″. A spring 363 is fixedly secured to the plate 357 and is configured to extend from the plate around the edge margin (e.g., top 18 or bottom 20) of the notebook 10. For instance, the spring 363 includes hook portions 361 that are somewhat analogous to the hook portions 161 of the clips 151, 153 described above. The hook portions 361 of the spring 363, however, are not in their relaxed state when the stand is separate from the structure that it supports, in contrast to the hook portions. Instead, the hook portions 361 are pre-stressed so that elastic restoration forces in the hook portions urge a clamping member 359 of the spring to move toward (and into engagement with) the mounting plate 133′″. The pre-stressed spring clip(s) 353 allow the stand to operate substantially as described above except that the pre-stressed spring clip(s) facilitate securement of the mounting member 131′″ to structures having a wider range of thicknesses than is feasible using the clips 151, 153 described above.

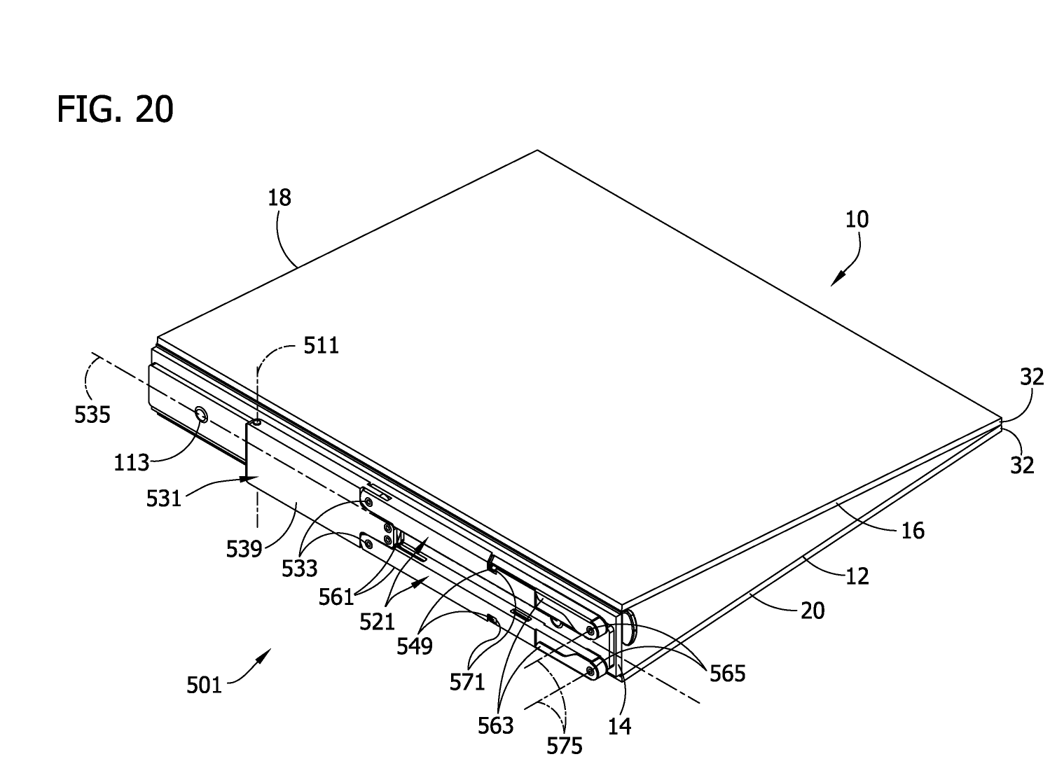

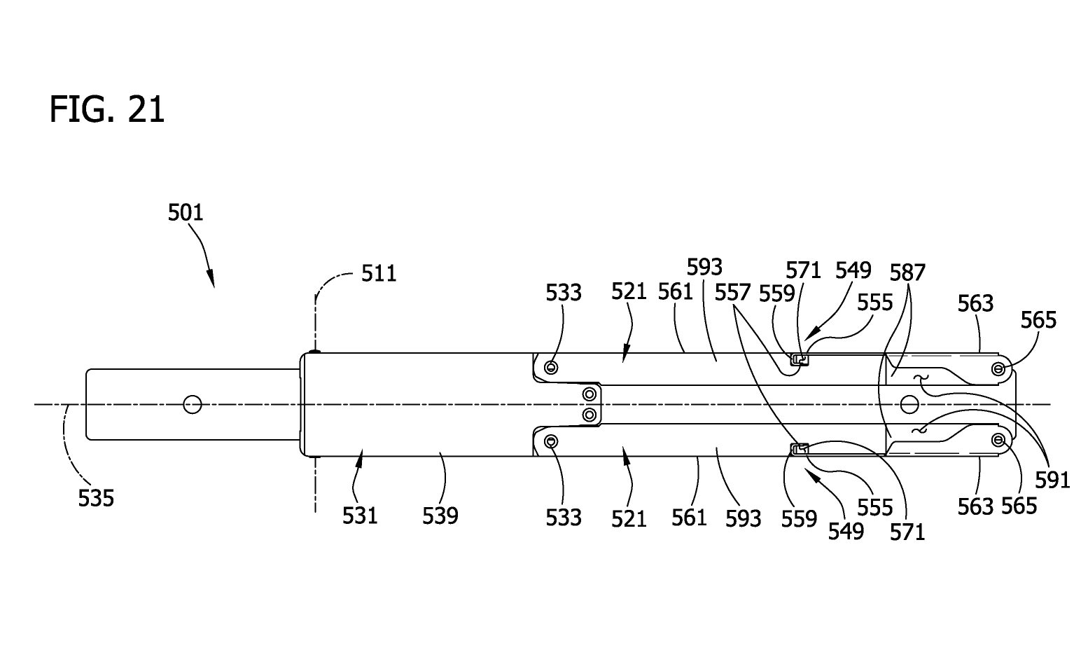

Referring to FIGS. 20-27, another embodiment of a stand of the present invention, generally designated 501, is illustrated secured to the notebook 10. Except as noted, the stand is constructed and operated in substantially the same way as the stand 101 described above. In this embodiment, the rivets 113 are used to secure the stand and the binder mechanism to the spine 14 of the notebook instead of the clips 151, 153 described above.

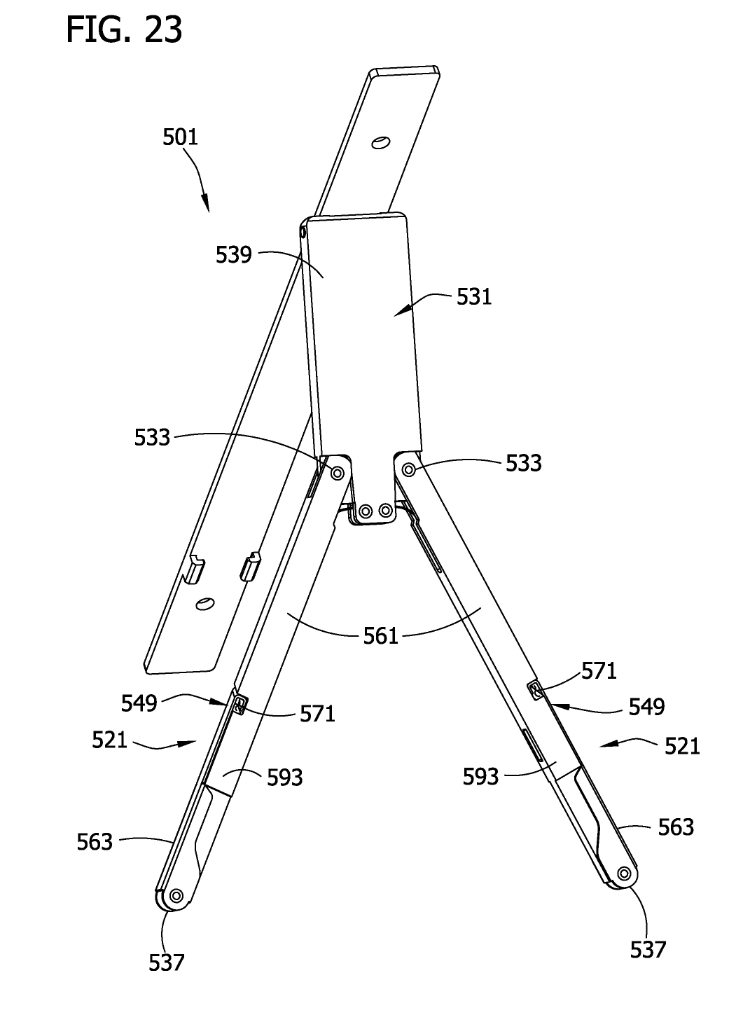

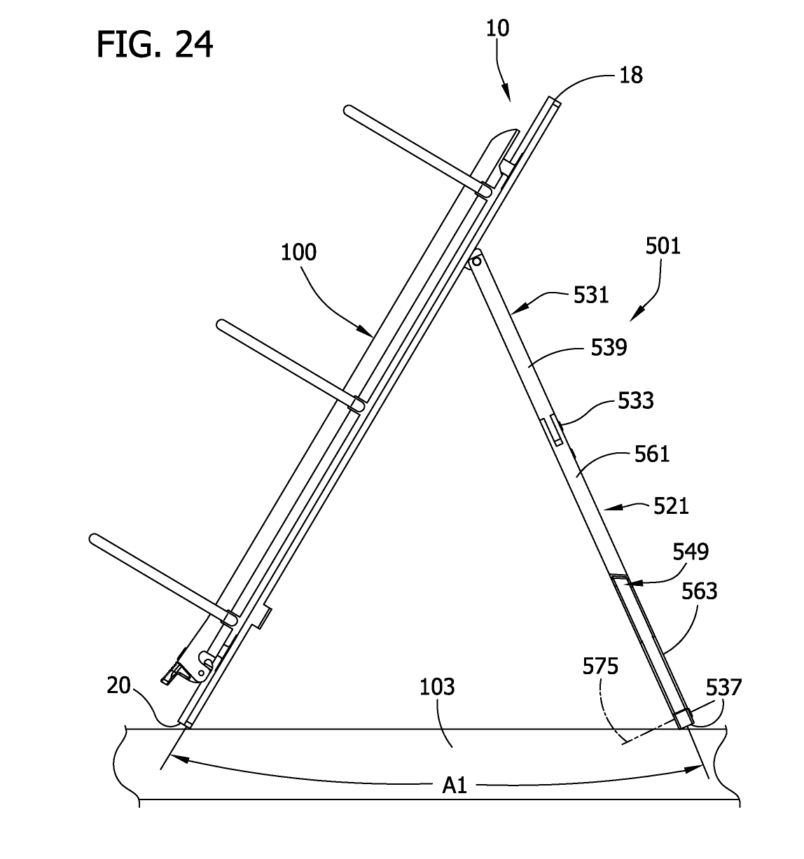

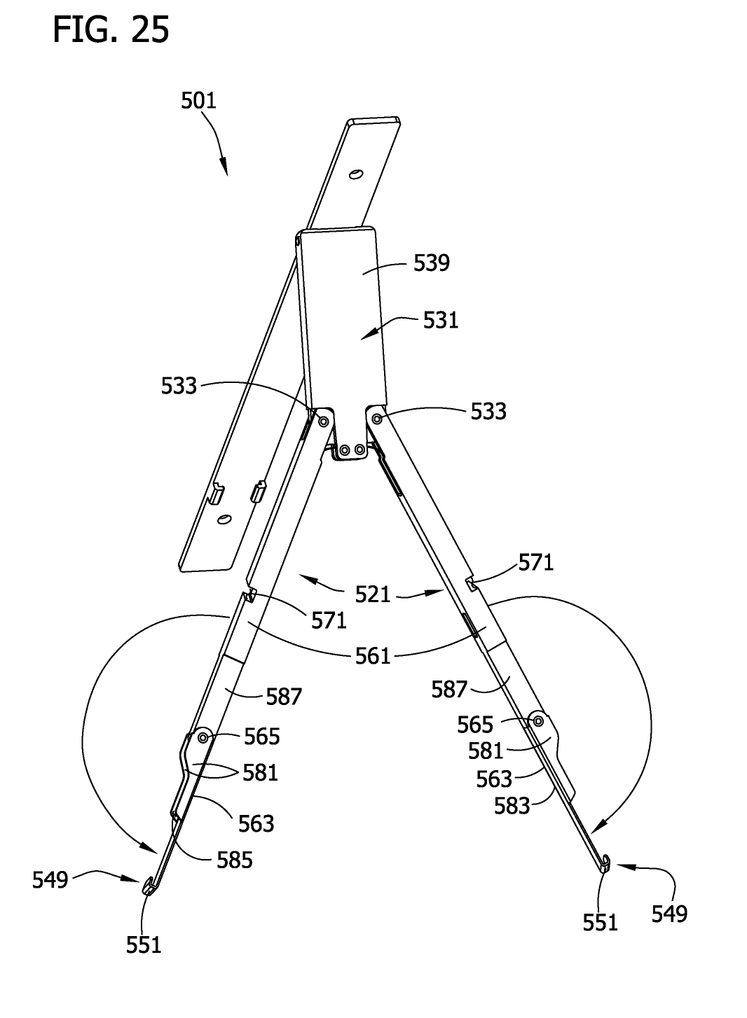

The legs 521 of the support member 531 in this embodiment are selectively reconfigurable between a first configuration (FIGS. 23-24) in which the legs have a relatively shorter length and a second configuration (FIGS. 25-27) in which the legs have a relatively longer length. When the legs 521 are in their relatively shorter configuration, the stand 501 is operable to support the notebook 10 in substantially the same way as the stand 101 described above. Thus, as illustrated in FIG. 24, the stand 501 is able to support the notebook 10 on a work surface 103 in an inclined position in which the bottom 20 of the notebook is adjacent (e.g., in contact with) the work surface and the top 18 of the notebook is above the work surface to facilitate hands free viewing of the pages retained in the notebook by a user.

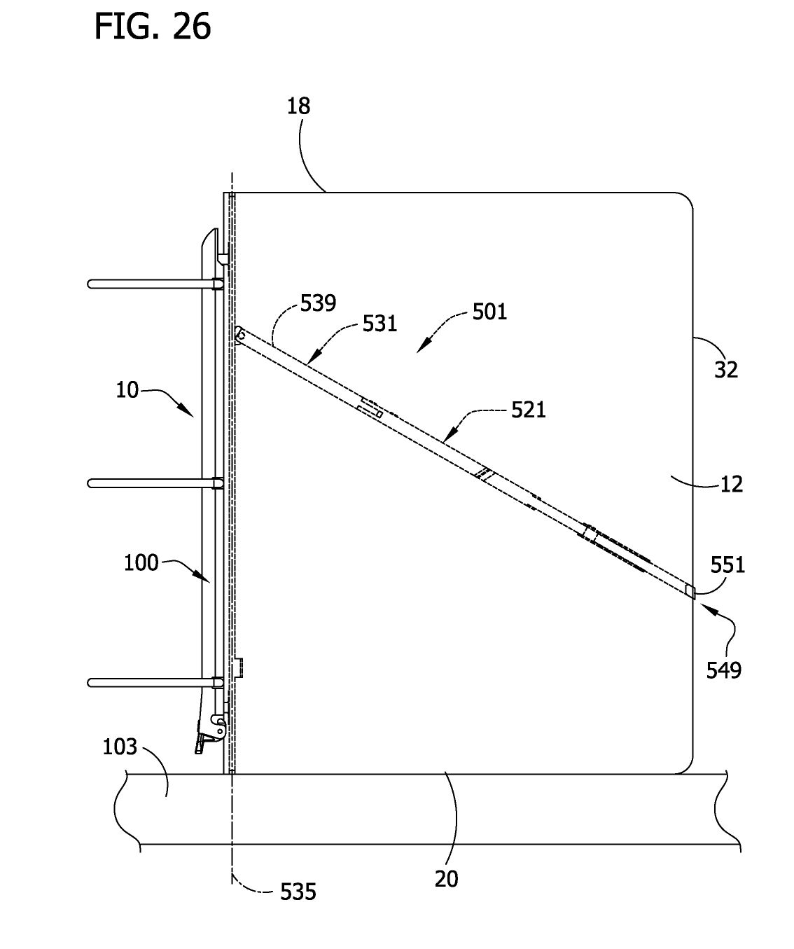

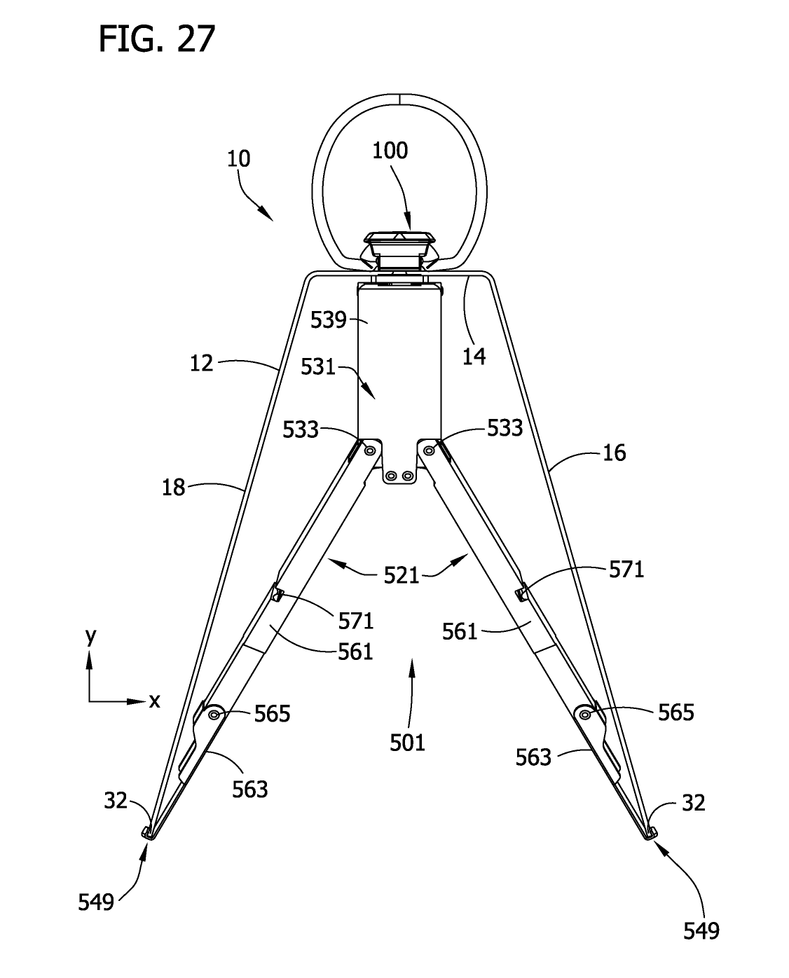

When the legs 521 are in their relatively longer configuration, the legs can be secured to the front and back covers 12, 16 of the notebook 10 to retain the front and back covers in a desired orientation relative to the spine 14 and one another. In the embodiment illustrated in FIGS. 26-27, for example, the legs 521 are secured to the front and back covers 12, 16 (e.g., by hooks 549 on the legs extending around side edges 32 of the covers) to retain them in an open configuration in which the covers are opened beyond the point at which they are co-planar and pages retained in the notebook are viewable by a user. Further, when the spine 14 and covers 12, 16 are in this open configuration, the notebook 10 is able to support itself on the work surface 103. The use of the legs 521 to capture the front and back covers 12, 16 will be described more fully hereinafter.

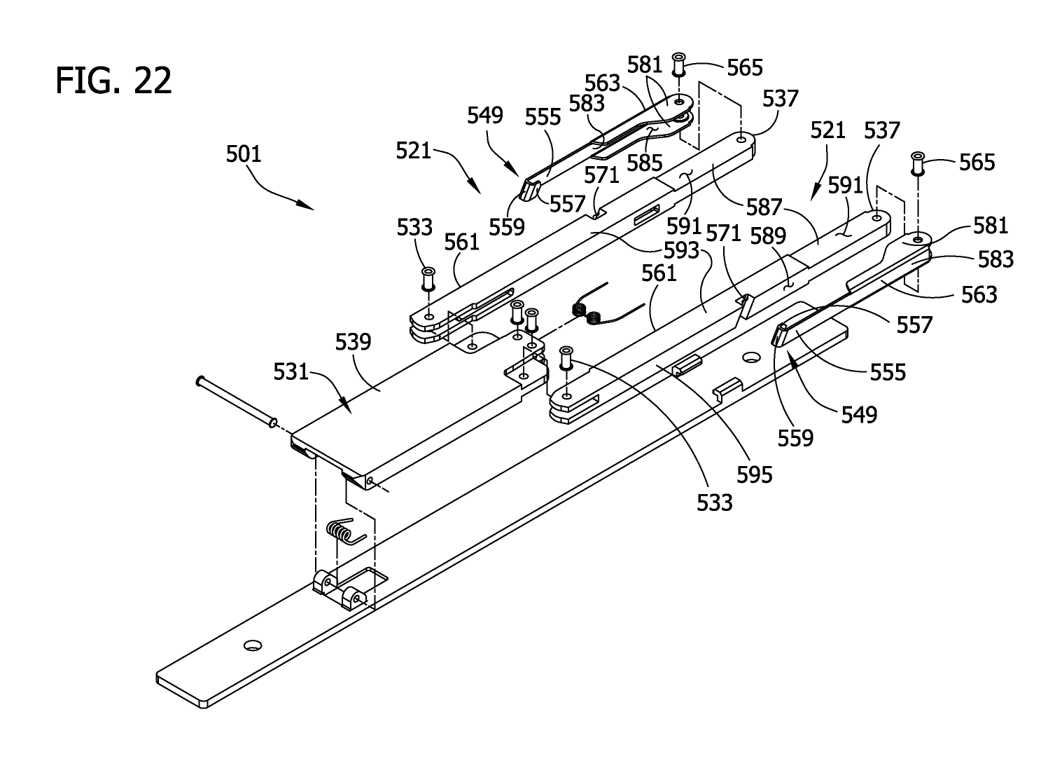

As best illustrated in FIG. 22, each of the legs 521 in this embodiment includes an upper leg portion 561 secured to the bracket 539 of the support member 531 for pivoting movement relative to the bracket (e.g., by a pin 533 or other suitable fastener). Each leg also includes a lower leg portion 563 secured to the upper leg portion 561 for pivoting movement of the lower leg portion relative to the upper leg portion about a pivot axis 575 (FIG. 20) that is substantially perpendicular to the pivot axis 511 about which the support member 531 rotates between its stowed and support positions. In the illustrated embodiment, for instance, the lower leg portions 563 are secured to the upper leg portions 561 at ends 537 of the upper leg portions opposite the bracket 539 by pins 565 or other suitable fasteners. In the shorter (retracted) configuration of the legs 521, the lower leg portions 563 are oriented so they extend from the connecting pins 565 back toward the bracket 539. Thus, in the shorter configuration, the ends 537 of the upper leg portions 561 are the ends of the legs 521. In order to reconfigure the legs 521 to their second configuration, a user rotates the lower leg portions 563 relative to the upper leg portions 561 (as indicated by the arrows on FIG. 25) until the lower leg portions extend from the pin connections 565 away from the bracket 539, thereby extending the length of the legs. In the illustrated embodiment, the lower leg portions 563 rotate about 180 degrees relative to the upper leg portions 561 to convert the legs 521 from their shorter configuration to their longer configuration. The hooks 549 are suitably at the ends 551 of the lower leg portions 563 that are opposite the pin connection 565. Thus, the hooks 549 are at the ends 551 of the legs 521 in the second configuration. The legs 521 are also suitably substantially straight in the second configuration, as they are in the first configuration.

The upper and lower leg portions 561, 563 are suitably configured to minimize the profile of the legs 521 in the first configuration. As illustrated in FIG. 22, for example, each of the lower leg portions 563 has a pair of spaced apart mounting tabs 581 on opposite sides of the upper leg portion 561. The pins 565 extend through the mounting tabs 581 to secure the lower leg portion to the upper leg portion. The mounting tabs 581 extend away from a connecting plate 583 that is configured to conform to the upper leg portion in the first configuration. Together the mounting tabs 581 and plate 583 define a channel 585 sized and shaped to be in substantially conformal relation with a segment 587 of the upper leg portion 561 that is at least partially received in the channel in the first configuration. In the illustrated embodiment, for example, the mounting tabs 581 and plate 583 are generally flat and arranged to define a generally rectangular channel 585, which is in substantially conformal relation with a segment 587 of the upper leg portion 561 having a generally rectangular cross section. When the legs 521 are in the shorter configuration, the mounting tabs 581 suitably grip the upper leg portion 561 (e.g., via friction associated with an interference fit therewith) to releasably hold the legs in the shorter configuration.

The segment 587 of the upper leg portion 561 that is received in the channel 585 suitably has a narrower width than other parts of the upper leg portion. In one embodiment, the upper leg portions 561 have recessed areas 591 to accommodate the mounting tabs 581 so that the mounting tabs are generally aligned with the sides 593 of the legs 521 in the first configuration. The upper leg portions 561 also have recessed areas 589 to accommodate the connecting plate 583 so the plate is generally flush with a side 595 of the respective upper leg portion. Further, each of the upper leg portions 561 defines a recess 571 sized and shaped to accommodate the hooks 549 on the ends 551 of the lower leg portions 563 in the first configuration. Thus, in this embodiment, the entirety of each lower leg portion 563 in the first configuration is positioned substantially within a volume defined by the largest cross sectional shape of the upper leg portion 561 projected axially along the longitudinal axis of the respective leg.

As illustrated in FIGS. 26-27, when the legs are in their longer configuration and the covers 12, 16 are in the open configuration (FIG. 27), the support member 531 extends all the way from the spine 14 of the notebook 10 to the side edges 32 of the covers. In the embodiment illustrated in FIG. 26, the support member 531 is secured to the spine 14 at a location that is relatively closer to the top 18 of the notebook 10 and secured to the edges 32 of the covers at locations that are relatively farther from the top of the notebook. The support member is suitably secured to the edges 32 of the covers 12, 16 at locations that are spaced above the bottom 20 of the notebook 10, as illustrated in FIG. 26. The support member 531 is not positioned to contact the work surface 103 when it is secured to the covers 12, 16 in this manner.

As best seen in reference to FIGS. 20, 22, and 26, the hooks 549 in the illustrated embodiment are configured to conform to the side edges 32 of the covers 12, 16 when the hooks are used to secure the legs 521 to the covers. For example, the mounting member has a longitudinal axis 535 that is generally parallel to the orientation of the side edges 32 when the stand 501 is secured to the notebook 10, as illustrated in FIG. 26. Each of the hooks comprises a shank 555, a free end 557, and a connecting portion 559 secured to the shank and the free end. The connecting portion 559 holds the free end 557 relative to the shank 555 in generally opposing relation to one another so the edges 32 of the notebook covers 12, 16 can be received therebetween. The connecting portion 559 is also configured so it is generally parallel to the longitudinal axis 535 of the mounting member when the support member 531 and legs 521 are in their support positions and the legs are in the longer configuration. Thus, the connecting portions 559 of the hooks 549 are generally parallel to and in conformal relation with the side edges 32 of the covers 12, 16 when the support member 531 is secured to the covers in the manner illustrated in FIG. 26.

In use, the stand 501 can remain secured to the notebook 10 while a user selectively adapts the stand for storage by positioning the support member 531 and legs 521 in their support positions (FIG. 20) in generally the same manner described above. The user can also move the support member 531 and legs 521 to their support positions to support the notebook 10 on the work surface 103. The user may leave the legs 521 in their shorter configuration in order to configure the stand 501 for supporting the notebook 10 in an inclined position relative to the work surface 103 (FIG. 24), in which case the stand operates in substantially the same manner as the stand 101 described above. The user may additionally or alternatively reconfigure the legs 521 to their longer configuration by pivoting the lower leg portions 563 to extend the legs. With the legs in their longer configuration, the user may secure the support member 531 to the covers 12, 16 to maintain them in a configuration in which the notebook 10 supports itself on the work surface 103. Thus, the user can use the stand 501 to selectively support the notebook 10 in the inclined position (FIG. 24) or in the upright open configuration (FIGS. 26-27) to suit the user's preference and/or meet the needs of a particular application.

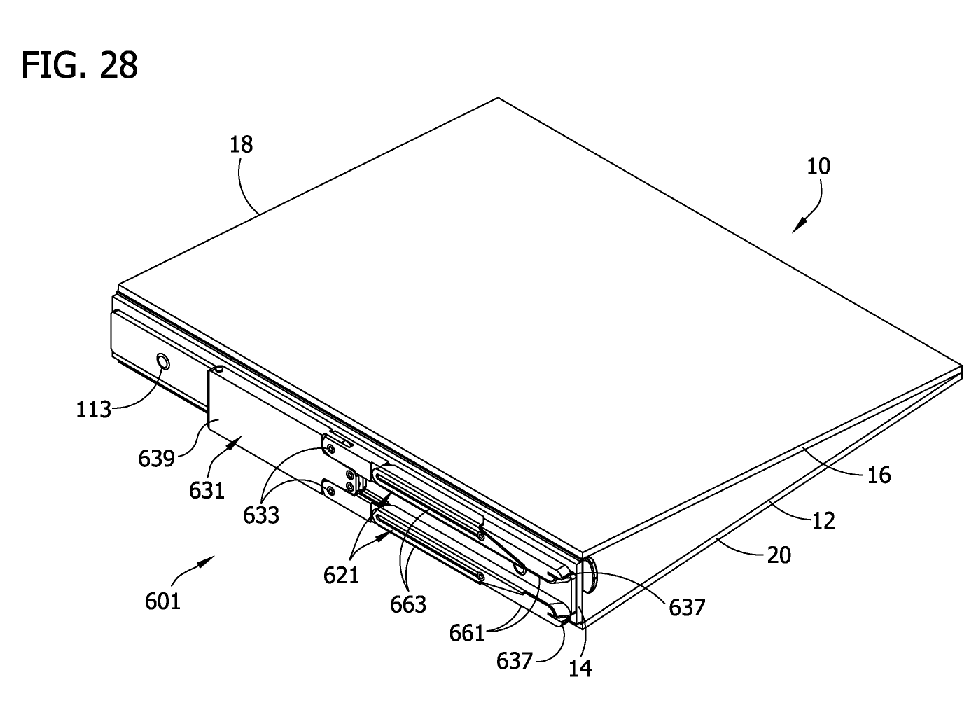

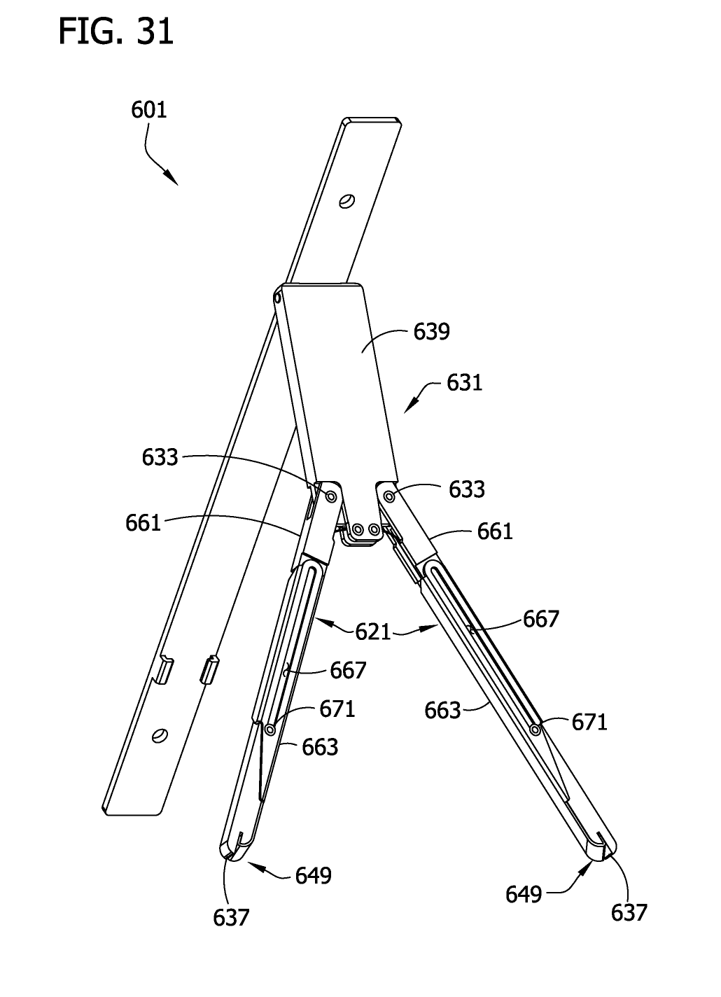

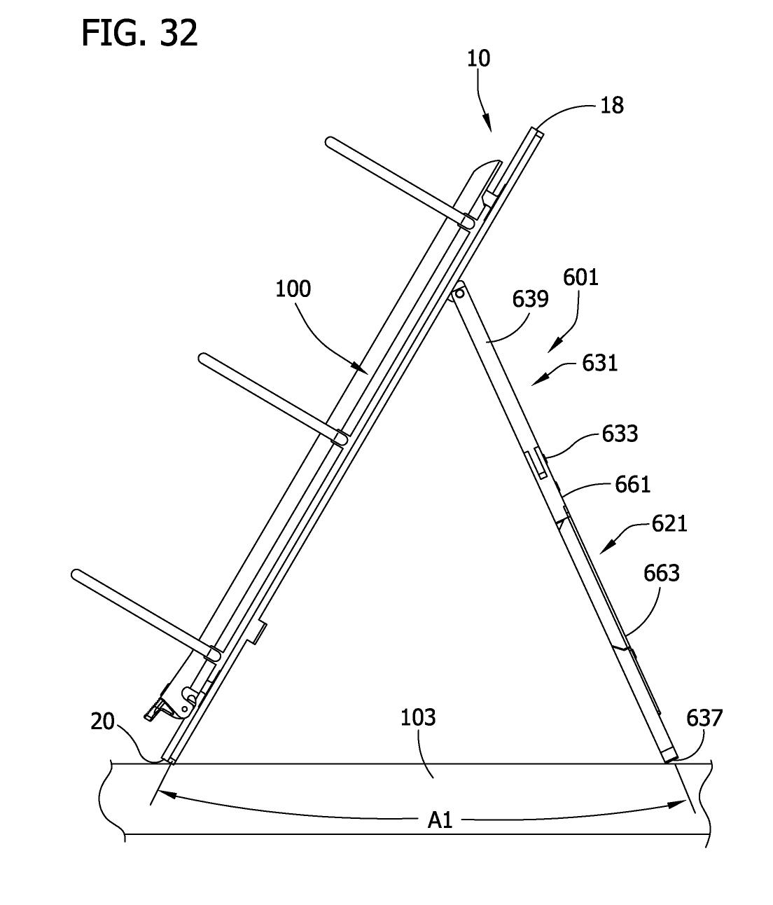

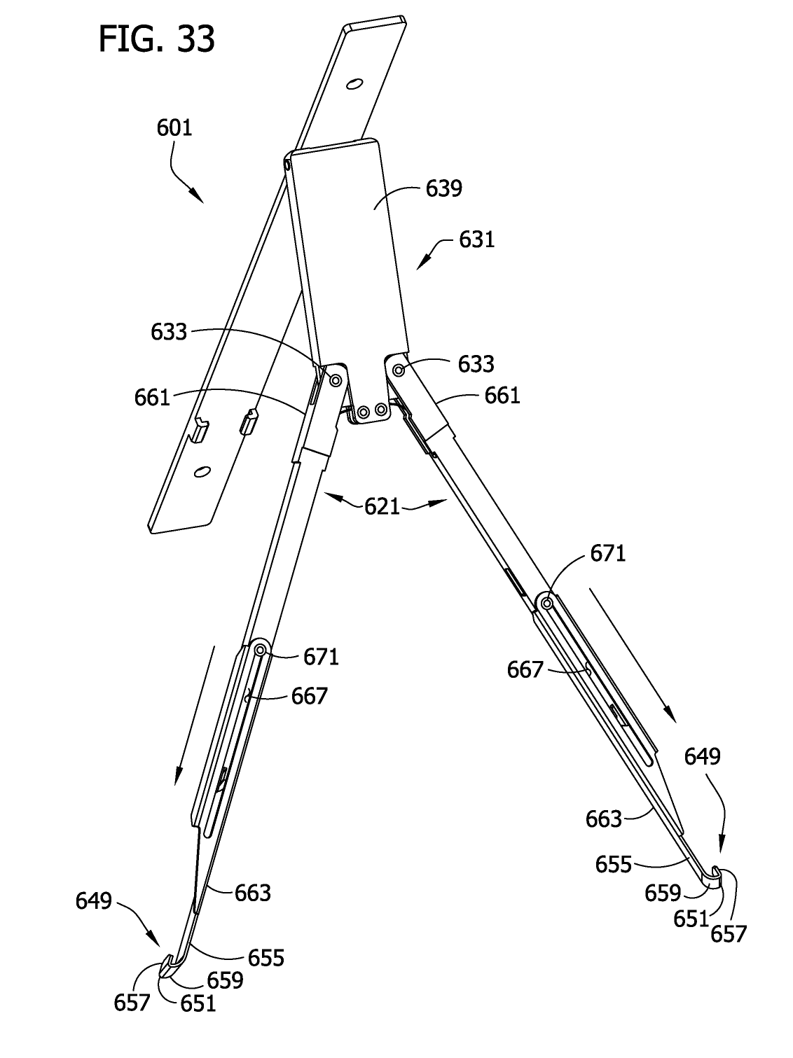

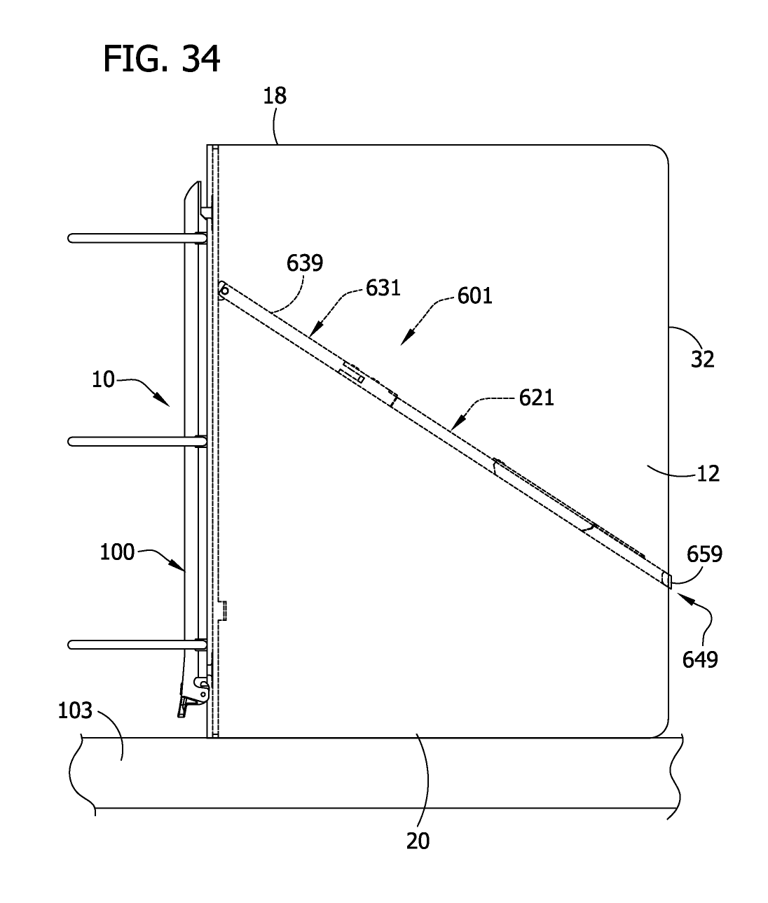

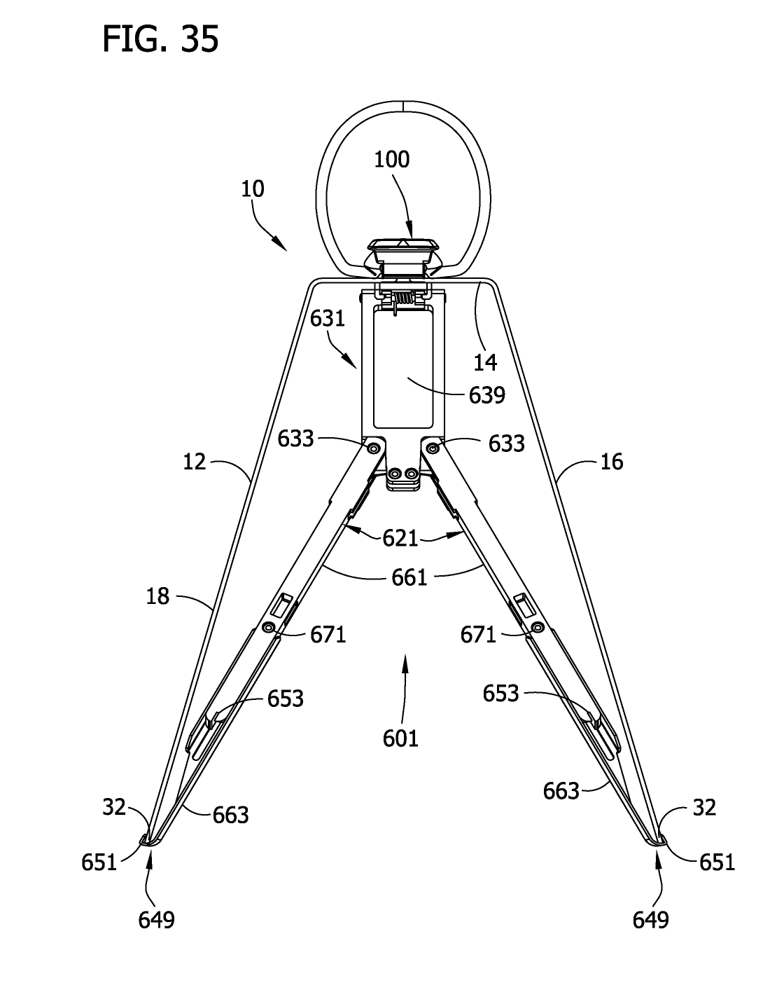

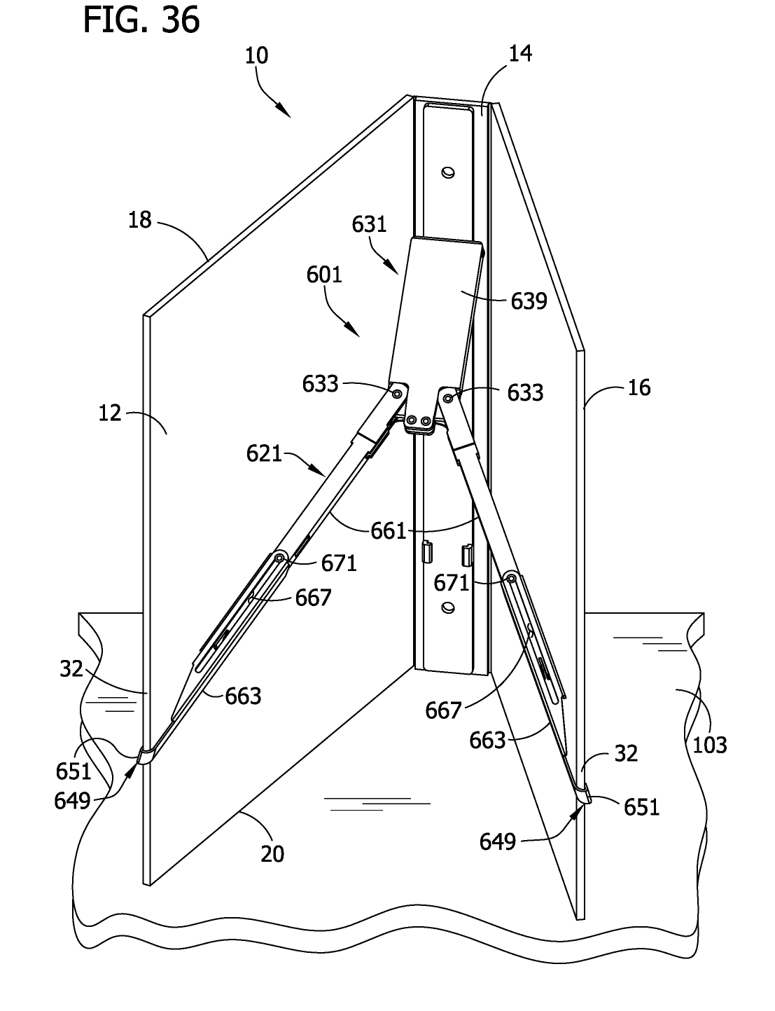

Another embodiment of a stand of the present invention, generally designated 601, is illustrated in FIGS. 28-36. This stand 601 is constructed and operated in substantially the same way as the stand 501 described above except as noted. In particular, the legs 621 of the stand are selectively reconfigurable between a shorter configuration for supporting the notebook 10 on the work surface 103 in an inclined position (FIG. 32) and a longer configuration for holding the notebook in an open configuration in which the notebook is able to support itself upright on the work surface (FIGS. 34-36).

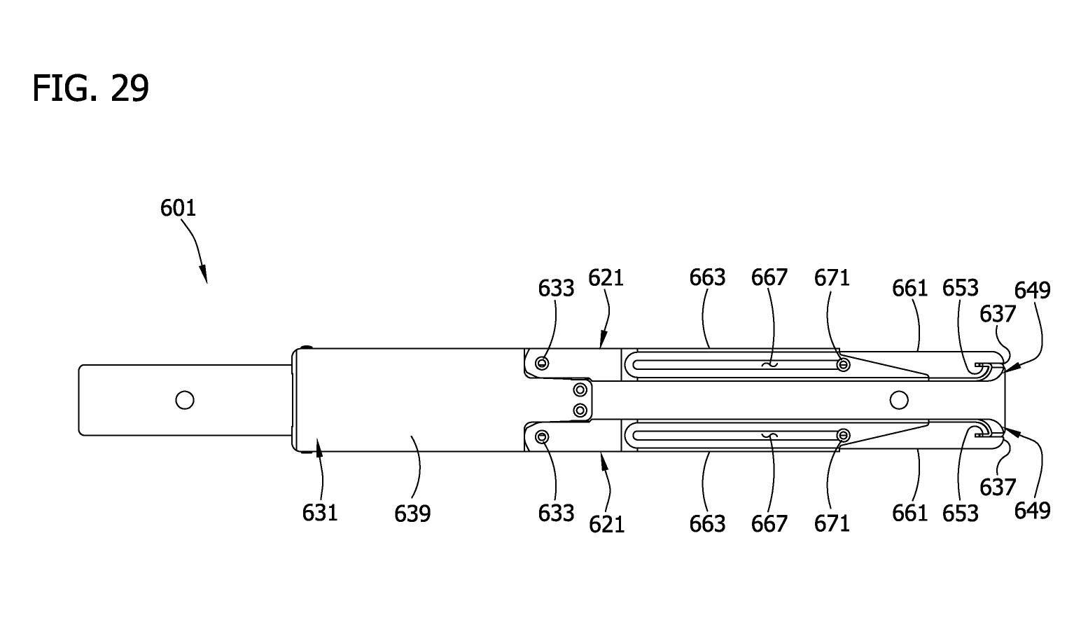

In contrast to legs 521 of the stand 501 described above, the legs 621 of this embodiment are constructed for telescoping movement of the legs between the shorter and longer configurations. It will be understood that other mechanisms for extending and retracting the legs may be used without departing from the scope of the present invention. As best seen in FIGS. 29-31, each of the legs 621 of this embodiment includes an upper leg portion 661 secured to the bracket 639 of the support member 631 (e.g., by a pin 633 or other suitable fastener) for pivoting movement of the upper leg portion relative to the bracket between the stowed and support positions of the legs. Each leg 621 also includes a lower leg portion 663 secured to the upper leg portion 661 for sliding movement of the lower leg portion relative to the upper leg portion lengthwise of the leg 621.

In the illustrated embodiment, for example, the lower leg portion 663 has an axially extending slot 667 therein. The lower leg portion 663 is secured to the upper leg portion 661 by a pin 671 that extends through the slot 667 so the pin moves between the ends of the slot as the lower leg portion slides relative to the upper leg portion to reconfigure the legs 621 between the shorter configuration and the longer configuration. In the shorter configuration, the lower leg portion 663 is in a retracted position in which substantially all parts of the lower leg portion overlie the upper leg portion 661. Thus, in the shorter configuration, the ends 637 of the upper leg portions 661 are the ends of the legs 621. In the longer configuration of the legs 621 the lower leg portions 663 are in an extended position relative to the upper leg portions 661 and extend away from the bracket 639 beyond the ends 637 of the upper leg portions. Thus, in the longer configuration, the ends 651 of the lower leg portions are the ends of the legs.

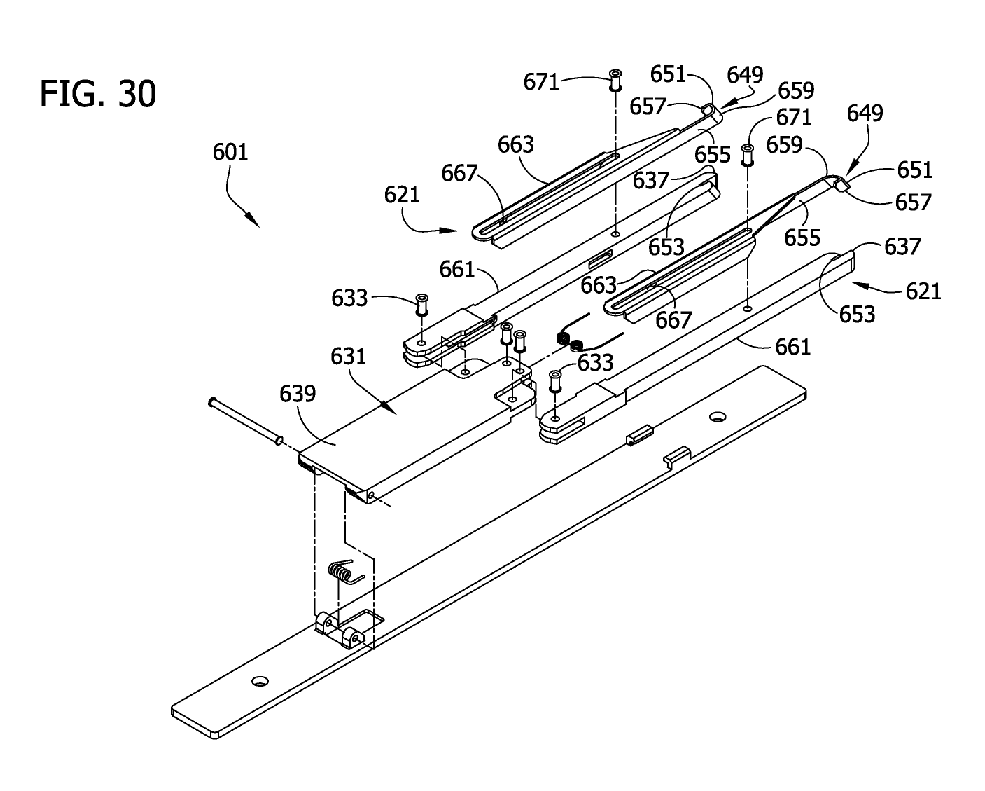

The lower leg portions 663 have hooks at their ends 651 that can be secured to the edges 32 of the notebook covers 12, 16 in substantially the same way as the hooks 549 described above. As shown in FIG. 30, each hook 649 includes a shank portion 655, a free end 657, and a connecting portion 659, each of which is analogous to its counter part in the hooks 549 described above. The ends 637 of the upper leg portions 661 are shaped to receive the free ends 657 of the hooks 649 in the shorter configuration of the legs 621. As best seen in reference to FIGS. 29-31, the ends 637 of the upper leg portions 661 have axially extending slots 653 positioned to receive the free ends 657 of the hooks 649 as the lower leg portions 663 slide into their retracted position during reconfiguration of the legs 621 to their shorter configuration. Because the free ends 657 of the hooks 649 are stowed in the slots 653 when the stand is configured for storage (FIG. 28) and when the ends 637 of the legs 621 engage the work surface 103 to support the notebook in the inclined position (FIG. 32) the free ends 657 of the hooks are protected from being accidentally damaged or from catching on other structures.

When the lower leg portions 663 are in their retracted positions, friction between the upper leg portions 661 and lower leg portions suitably releasably holds the legs 621 in the shorter configuration. For instance, the free ends 657 of the hooks 649 can be sized relative to the slots 653 to produce interference fits that releasably hold the lower leg portions 663 in their retracted positions until a user moves the lower leg portions to reconfigure the legs 621.

This embodiment of the stand 601 operates in substantially the same way as the stand 501 described above, except that a user slides the lower leg portion 663 relative to the upper leg portion 661 to reconfigure the legs 621 between the shorter and longer configurations.

It is understood that various modifications and/or alterations to the embodiments described in detail herein may be made without departing from the scope of the invention. For instance, it is understood that a support member as described above may be connected directly to a notebook (or other structure for retaining loose-leaf pages) without any separate mounting member without departing from the scope of the invention.

When introducing elements of the present invention of the preferred embodiments thereof, the articles “a”, “an”, “the” and “said” are intended to mean that there are one or more of the elements. The terms “comprising”, “including”, and “having” are intended to be inclusive and mean that there may be additional elements other than the listed elements.

In view of the foregoing, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A stand for supporting a structure for holding one or more pages, the stand comprising:
a mounting member for securing the stand to said structure, the mounting member having a mounting surface adapted to engage said structure;
a support member secured to the mounting member, the support member being moveable relative to the mounting member between a stowed position and a support position, the support member being disposed at a relatively larger angle relative to the mounting surface in the support position and at a relatively smaller angle relative to the mounting surface in the stowed position, the support member comprising a pair of legs moveable between a stowed position and a support position, respectively, the legs defining at least in part a base of the support member, the base having a relatively wider width when the legs are in their support positions and a relatively narrower width when the legs are in their stowed positions, each of the legs being selectively reconfigurable between a first configuration in which the leg has a relatively shorter length and a second configuration in which the leg has a relatively longer length.

2. A stand as set forth in claim 1 wherein the legs each comprise a lower portion and an upper portion mounted on the upper portion for extension and retraction relative to the upper portion for changing the length of the leg.

3. A stand as set forth in claim 2 wherein the support member comprises a connector mounting the lower portion on the upper portion for movement of the lower portion relative to the upper portion.

4. A stand as set forth in claim 3 wherein the connector comprises a pin.

5. A stand as set forth in claim 4 wherein the pin pivotally mounts the lower portion on the upper portion.

6. A stand as set forth in claim 5 wherein the lower portion of each leg has an end comprising a hook and the upper portion of each leg defines a recess, the hooks being received in the recesses when the legs are in said first configuration.

7. A stand as set forth in claim 5 wherein the support member is moveable relative to the mounting member between its stowed and support positions on a first pivot axis, the lower leg portions being moveable relative to the respective upper leg portion about pivot axes that are substantially perpendicular to the first pivot axis.

8. A stand as set forth in claim 4 wherein the pin mounts the lower portion for lengthwise sliding motion relative to the upper portion.

9. A stand as set forth in claim 8 wherein the upper member is positioned for engaging a work surface when the legs are in said first configuration and the lower member has an end positioned to engage said structure for holding one or more pages when the legs are in said second configuration.

10. A stand as set forth in claim 8 wherein the lower member of each leg has an end comprising a hook including a free end and the upper member of each leg has an end defining a slot, the free end of the hook being received in the respective slot when the legs are in said first configuration.

11. A stand as set forth in claim 8 wherein one of the upper and lower members defines a slot, the other of the upper and lower members being secured to the pin slidably mounted in the slot.

12. A stand as set forth in claim 1 in combination with said structure for holding one or more pages wherein the structure comprises a notebook having a spine, a front cover, and a back cover, the spine being between the front and back covers and connected to the front and back covers in a manner that allows movement of the front and back covers relative to the spine, the mounting member being secured to the notebook.

13. A stand and notebook combination as set forth in claim 12 wherein the legs are adapted to be secured to the front and back covers, respectively, when the legs are in the second configuration.

14. A stand and notebook combination as set forth in claim 12 wherein the legs are in said second configuration and secured to the front and back covers, respectively, such that the stand maintains the orientation of the front and back covers relative to the spine.

15. A stand and notebook combination as set forth in claim 14 wherein the front and back covers each have a side edge opposite the spine and the ends of the legs are secured to the side edges of the front and back cover, respectively.

16. A stand for supporting a structure for holding one or more pages, the stand comprising:
a mounting member for securing the stand to said structure, the mounting member having a mounting surface adapted to engage said structure;
a support member secured to the mounting member, the support member being moveable relative to the mounting member between a stowed position and a support position, the support member being selectively reconfigurable between a first configuration in which the support member is adapted to engage a work surface supporting said structure and a second configuration in which the support member is adapted to be secured to said structure to hold the structure in a configuration in which it can be supported upright on said work surface.

17. A stand as set forth in claim 16 in combination with said structure wherein the structure comprises a notebook having a spine, a front cover, and a back cover, the spine being between and secured to the front and back covers, the mounting member being secured to the spine.

18. A stand and notebook in combination as set forth in claim 17 wherein the spine and front and back covers each have a bottom edge, the support member is adapted to engage a substantially planar work surface while the bottom edges are adjacent the work surface and the support member is in said first configuration, and the support member does not engage the work surfaces when the bottom edges are adjacent the work surface and the support member is in its second configuration.

19. A notebook for holding one or more pages in combination with a stand for selectively supporting the notebook on a work surface, wherein the notebook comprises a spine, a front cover, and a back cover, the spine being between the front and back covers and secured thereto in a manner that allows the front and back covers to move relative to the spine for selectively covering and uncovering said pages, the stand comprising:
a support member secured to the notebook, the support member being moveable relative to the notebook between a stowed position and a support position, the support member being disposed at a relatively larger angle relative to the notebook in the support position and at a relatively smaller angle relative to the notebook in the stowed position, the support member comprising a pair of legs moveable between a stowed position and a support position, respectively, the legs defining at least in part a base of the support member, the base having a relatively wider width when the legs are in their support positions and a relatively narrower width when the legs are in their stowed positions, each of the legs being selectively reconfigurable between a first configuration in which the leg has a relatively shorter length and a second configuration in which the leg has a relatively longer length.

20. A notebook and stand in combination as set forth in claim 19 wherein each of the legs is adapted to be secured to a respective one of the front and back covers in its second configuration for retaining the front and back covers in a desired orientation relative to the spine.

21. A notebook for holding one or more pages in combination with a stand for selectively supporting the notebook on a work surface, wherein the notebook comprises a spine, a front cover, and a back cover, the spine being between the front and back covers and secured thereto in a manner that allows the front and back covers to move relative to the spine for selectively covering and uncovering said pages, the stand comprising:
a support member secured to the spine, the support member being moveable relative to the spine between a stowed position and a support position, the support member being selectively reconfigurable between a first configuration in which the support member is adapted to engage a work surface supporting the notebook and a second configuration in which the support member is adapted to be secured to the front and back covers to retain the front and back covers in a desired orientation relative to the spine.
